(19) United States
(12) Patent Application Publication
(10) Pub. No.: US 2009/0102152 A1
(43) Pub. Date: Apr. 23, 2009

(54) REAR RADIUS ARM AND REAR RADIUS ARM MOUNT FOR IMPROVED HANDLING OF FACTORY AND LIFTED LARGE-SCALE SUSPENSION STROKES AND ARTICULATIONS FOR ON AND OFF ROAD VEHICLES

(75) Inventor: Ryan Wallace, El Dorado Hills, CA (US)

Correspondence Address: JOHN P. O'BANION;O'BANION & RITCHEY LLP, 400 CAPITOL MALL SUITE 1550, SACRAMENTO, CA, 95814, US

(73) Assignee: RUBICON MANUFACTURING, INC., Rancho Cordova, CA (US)

(21) Appl. No.: 12/250,909

(22) Filed: Oct. 14, 2008

Related U.S. Application Data
(60) Provisional application No. 60/979,747, filed on Oct. 12, 2007.
(60) Provisional application No. 60/982,423, filed on Oct. 25, 2007.
(60) Provisional application No. 60/982,987, filed on Oct. 26, 2007.
(60) Provisional application No. 60/983,152, filed on Oct. 26, 2007.

(51) Int. Cl. B60G 9/02; B60G 9/00

(52) U.S. Cl. 280/124.11; 280/124.1; 280/80.1

(57) ABSTRACT

A rear axle radius arm reduces chassis-induced roll oversteer and improves handling and safety both on and off road. Each rear axle radius arm has a single point of frame attachment in a variety of locations, and pivots on a center, allowing lifting to relatively large heights, very large suspension strokes, and high degrees of axle articulation. Four factory axle mounts on the stock axle may be used for many retrofit applications. An additional compliant bushing in the rear axle radius arm accommodates movement in an otherwise fully constrained rear axle suspension design. The additional bushing is another reason why this design improves vehicle performance so much, as it allows for increased axle articulation (differential wheel elevations) with reduced torque applied to the axle and control arm attachment brackets.

### CROSS-REFERENCE TO RELATED APPLICATIONS

This application claims benefit of priority to U.S. provisional patent application Ser. No. 60/979,747 filed Oct. 12, 2007, hereby incorporated by reference in its entirety, U.S. provisional patent application Ser. No. 60/982,423 filed on Oct. 25, 2007, incorporated herein by reference in its entirety, U.S. provisional patent application 60/982,987 filed on Oct. 26, 2007, incorporated herein by reference in its entirety, and U.S. provisional patent application Ser. No. 60/983,152 filed Oct. 26, 2007, incorporated herein by reference in its entirety.

### STATEMENT REGARDING FEDERALLY SPONSORED RESEARCH OR DEVELOPMENT

Not Applicable.

### INCORPORATION-BY-REFERENCE OF MATERIAL SUBMITTED ON A COMPACT DISC

Not Applicable.

### BACKGROUND OF THE INVENTION

1. Field of the Invention

This invention pertains generally to automotive suspension components that undergo large strokes and axle articulations during on and off road conditions, more particularly to rear radius arms that connect an automotive frame to a rear axle to improve vehicle handling characteristics when at or lifted above the factory design, and still more particularly to chassis modifications that allow for aftermarket addition of rear radius arms.

2. Description of Related Art

Off road vehicles have developed the capacity for large-excursion wheel movements both on and off road. Typically, off road performance is traded off against on road performance. In the past, such trade off was common.

Front radius arms were first implemented by Rubicon Manufacturing, Inc. in 1997. These front radius arms allowed for improved on and off road performance improvements, without detracting from either.

United States patent application US 2006/0033298, entitled “Vehicle Suspension with Improved Radius Arm to Axle Attachment” is hereby incorporated by reference in its entirety.

### BRIEF SUMMARY OF THE INVENTION

An aspect of the invention is a rear axle radius arm that comprises: a frame on one side of an automobile; and means for linking a rear axle to the frame. The means for linking the rear axle to the frame may comprise: a bracket attached to the frame; the frame comprising: a medial side closer to a front-to-back medial plane of substantial symmetry in the automobile; a distal side further away from the medial plane than the medial side; a bottom side; and a radius arm movably attached to the bracket mount, wherein the radius arm movably connects the rear axle to the bracket.

By substantial symmetry, it is meant that frame rails are functional mirror images of each other, the doors and body panels substantially mirror each other (depending on the design), and the wheels are disposed equidistantly from the plane of substantial symmetry. The plane of substantial symmetry would ideally intersect the center of gravity of the vehicle. For example, with a 2, 4, or 6 seating vehicle, the driver and front passenger are substantially equidistant from the vertical plane of substantial symmetry between them. For 3, 6, or 9 seated vehicles, the middle seat would intersect the plane of substantial symmetry. This all assumes that the seating for each row of seats are equal. A less precise, but perhaps more informative notion of the plane of substantial symmetry would be the vertical front-to-back “middle” plane that would separate the driver side of the vehicle from the (front seat) passenger side.

The means for linking the rear axle to the frame may comprise: a movable joint that connects to the frame; a first compliant pivot that attaches to a first mount on the rear axle; and a second compliant pivot that attaches to a second mount on the rear axle. An intermediate compliant pivot may be disposed between the movable joint and the second compliant pivot. Alternatively, a substantially noncompliant intermediate attachment point may be disposed between the movable joint and the second compliant pivot, wherein the first compliant pivot, the second compliant pivot, and the movable joint are rigidly connected by a substantially rigid connection (aside from temporary recoverable deformations due to torsion and bending). These temporary recoverable deformations are insufficient to permanently yield the material into a permanent deformation.

The bracket above may comprise: a doubler plate attached to a first side of a frame; a cuff attached to a lower side of the frame and through a second side of the frame opposing the first side of the frame to the doubler plate; and a control arm mount attached to the cuff, comprising a shaft wherein a movable link may be rotationally or spherically movably attached to the shaft. When so assembled, the doubler plate, cuff, and control mount are removably mounted to the frame in an extremely stiff manner. Additionally, this arrangement of the doubler plate and cuff acts to distribute loads placed on the frame from the control arm mount, and stiffens the frame where attached.

One or more of the upper compliant pivot, the intermediate compliant pivot, and the lower compliant pivots may allow for both rotational and tilt movements out of a plane of nominal rotation.

Another aspect of the invention is that the radius arm may comprise: (1) a lower control arm that comprises: a lower compliant pivot that connects to a lower mount on the rear axle at one end; a movable joint that connects to the bracket mount located on the frame at the other end; and (2) an upper control arm bracket located between the lower compliant pivot and the movable joint; and an upper control arm that comprises: an upper compliant pivot that connects to an upper mount on the rear axle at one end, and an intermediate compliant pivot that connects to the upper control arm bracket.

The rear axle radius arm may comprise one rear axle radius arm on each side of the medial plane of the automobile; and a center of rear suspension rotation, comprising a line drawn between the two brackets attached to the frame that substantially intersects a center of rotation of a double Cardan joint, wherein the double Cardan joint is connected at one end to a drive shaft that connects a differential, and at the other end to an output of a rotational power source. The rotational power source may comprise either a transfer case or a transmission.

The rear axle radius arms on each side of the medial plane may be substantially mirror images of each other.

The lower mount on the rear axle may previously have been attached to a factory installed rear lower control link. Similarly, the upper mount on the rear axle may previously have been attached to a factory installed rear upper control link.

The rear axle radius arm bracket may comprise: an aftermarket bracket attached to the frame. By aftermarket, it is meant that the bracket is generally not originally supplied by the original equipment manufacturer. The bracket may be attached to the distal side of the frame, the medial side of the frame, or the bottom side of the frame.

The bracket above may comprise a stamped locator that precisely locates the bracket by a factory frame precision reference locator.

Additionally, the bracket may be attached to the bottom side of the frame. In fact, it may be attached to the distal side, bottom side, and medial side of the frame, and may further curve to the top of the frame for additional support. The bracket may attach to the frame with components that comprise: (a) a cuff comprising a lower lip; (b) the bracket attached to the cuff; (c) a doubler plate; (d) wherein the radius arm attaches to the bracket; and (e) wherein the cuff bolts through the frame to the doubler plate; and (f) wherein the cuff lower lip attaches through the bottom side of the frame to a plate with retained fasteners.

The rear axle radius arm upper compliant pivot, the intermediate compliant pivot, and the lower compliant pivots may all allow for both rotational and translational movements, either rotational or translational movements, or no movement. Each of the upper compliant pivot, the intermediate compliant pivot, and the lower compliant pivots may comprise: a housing; a thick-walled tubular compliant bushing disposed within the housing; two caps that protrude into the inner diameter of the tubular compliant bushing that allow passage of a central shaft, wherein the housing and caps limit translational movement of the central shaft within the housing through limited deformation of the compliant bushing.

The vehicle stroke and articulation movements are possible with the rear axle relative to the vehicle frame. Stroke is allowed through rotation of the movable joint, where, if both radius arms simultaneously identically rotate, the rear axle moves up and down. Differential movements of the radius arms require axle articulation, which is accomplished through spherical motion of the movable joint, and through deformations in the compliant pivots that allow off-axis tilts of the pivots. A still further aspect of the invention is a method for retrofitting a rear axle connection to a frame with a set of two radius arms, the method for retrofitting each of the radius arms may comprise: providing a rear axle, the rear axle comprising: an upper control link mount and a lower control link mount, wherein both upper and lower control link mounts respectively connect to rear lower and rear upper control links that are in turn connected to the frame, such that the upper control link, the lower control link, the axle, and the frame form a moveable four-bar linkage wherein the axle moves relative to the frame; removing the upper control link and the lower control link; attaching a radius arm bracket mount to the frame on the distal side of the frame; installing a radius arm, the radius arm comprising: a lower radius control arm that spherically mounts to the frame bracket mount and the lower axle bracket mount; an upper radius arm that pivotally mounts to the upper radius arm bracket on the lower radius arm on one end, and pivotally attaches to the axle upper control link mount at the other end. In this manner a retrofitted vehicle may be built.

Another aspect of the invention may comprise: a frame on one side of an automobile, wherein: the automobile has a medial plane, and the frame has medial side closer to the medial plane, and a distal side further away from the medial plane than the medial side; and means for linking a rear axle to the frame.

The means for linking the rear axle to the distal side of the frame may comprise: a bracket mount located on the distal side of the frame; and a radius arm movably attached to the bracket mount, wherein the radius arm movably connects the rear axle to the bracket mount.

In still another aspect of the invention, a serviceable rear axle radius arm mount, may comprise: a vehicle chassis in a vehicle; and means for mounting two rear axle radius arms to the chassis. The means for mounting may further comprise: (a) a rear axle radius arm mount attached to the chassis; and (b) a separately removable section that may be separately removed from the rear axle radius arm mount; (c) wherein the rear axle radius arm has a substantially constant alignment both prior to and after removal of the separately removable section.

In another aspect, the serviceable rear axle radius arm mount may comprise: (a) two frames substantially bilaterally disposed about a medial plane of substantial vehicle symmetry; (b) two frame mounts bilaterally disposed about a separately removable section; (i) wherein each frame mount attaches to the vehicle chassis through one of the frames on one side, and to the separately removable section on the other side; (ii) wherein each frame mount has a pivot connection to a rear axle radius arm; and (c) each rear axle radius arm substantially radially connects the rear axle to the vehicle chassis.

In this aspect, removal of the separately removable section does not change the location or alignment of the rear axle radius arms, thus facilitating servicing by reducing removal and realignment time.

In another aspect of the invention, a serviceable transmission mount with front radius arm mounts may comprise: (a) a vehicle frame; (b) means for mounting two front radius arms, the means for mounting attached to the vehicle frame; and (c) means for supporting a transmission attached to the means for mounting the two front radius arms.

The means for supporting the transmission may be separately removable from the means for mounting the two front radius arms. Furthermore, the means for mounting the two front radius arms may comprise means for mounting two rear radius arms. In this instance, there may be a total of four radius arms mounted, and removal of the separately removable means for supporting the transmission does not affect the alignment of any of the radius arms or other suspension component.

The means for supporting the transmission may comprise: a structural member bolted to the transmission and removably bolted to the means for mounting the two front radius arms.

In still another aspect of the invention, the vehicle front end (that comprises front radius arms) remains in substantially identical front wheel alignment before removal and after replacement of the means for supporting the transmission.

Further aspects of the invention will be brought out in the following portions of the specification, wherein the detailed description is for the purpose of fully disclosing preferred embodiments of the invention without placing limitations thereon.

### BRIEF DESCRIPTION OF THE SEVERAL VIEWS OF THE DRAWING(S)

The invention will be more fully understood by reference to the following drawings which are for illustrative purposes only:

FIG. 1A is a side view of one embodiment of a rear axle radius arm.

FIG. 1B is a side view of the rear radius arm of FIG. 1A, with the intermediate compliant pivot 126 of FIG. 1A. replaced with a solid connection.

FIG. 1C is a side view of the rear axle radius arm of FIG. 1B, with a fixed or slidable length adjustment in the upper control arm.

FIG. 1D is a side view of the rear axle radius arm of FIG. 1B with the upper control arm longer than the lower control arm.

FIG. 1E is a side view of the rear axle radius arm of FIG. 1D, with a fixed or slidable length adjustment in the upper control arm.

FIG. 1F is a side view of a rear axle radius arm with an upper radial control arm, a lower radial control arm, where both control arms pivot about a common point.

FIG. 1G is a side view of the rear axle radius arm of FIG. 1F, where the upper control arm has a fixed or slidable length adjustment.

FIG. 1H is a side view of one embodiment of a rear axle radius arm, where a single control arm connects at the rear axle with two pivot point, and at the frame with a single pivot point.

FIG. 2 is a cross sectional view of a factory-supplied (PRIOR ART) rear axle configuration.

FIG. 3 is a side view of a factory drive train.

FIG. 4 is a side view of an aftermarket drive train modification, where the chassis has been significantly lifted.

FIG. 5 is a detailed assembly view of a compliant pivot.

FIG. 6A is a bottom perspective view of a first type of off road capable vehicle in a factory configuration with factory transfer case mount and wheel linkages.

FIG. 6B is a bottom perspective view of the off road capable vehicle of FIG. 6A with the factory transfer case mount and wheel linkages replaced with aftermarket enhancements.

FIG. 6C is a bottom perspective view of the off road capable vehicle of FIG. 6B with the center section of the replacement factory transfer case mount removed to allow for servicing of the transfer case, or component, with the front radius arm supports remaining in place.

FIG. 7A is a bottom perspective view of a second type of off road capable vehicle in a factory configuration with factory skid plate and wheel linkages.

FIG. 7B is a bottom perspective view of the off road capable vehicle of FIG. 7A with the factory skid plate and wheel linkages replaced with aftermarket enhancements.

FIG. 7C is a bottom perspective view of the off road capable vehicle of FIG. 7B with the center section of the replacement skid plate and radius arm support removed to allow for servicing of the transmission, driveline, or transfer case, with the front and rear radius arm supports remaining in place without need of any adjustment.

FIG. 8A is an exploded perspective view of a bracket for aftermarket or factory mounting of a radius arm opposite the radius arm mounting location.

FIG. 8B is an exploded perspective view of a bracket for aftermarket or factory mounting of a radius arm on the same side as the radius arm mounting location.

FIG. 9A is a perspective view of a radius arm lower control link.

FIG. 9B is a perspective view of the radius arm lower control link of FIG. 9A, with the movable joint exploded so that the internal components may be viewed.

FIG. 10A is a plan view of the distal side (outside) of a chassis with radius arms, showing the front (on the right hand side) and rear (on the left hand side) axles connected with respective front and rear radius arms.

FIG. 10B is a plan view of the medial side (inside) of the chassis with radius arms of FIG. 10A, showing the front (on the left hand side) and rear (on the right hand side) axles connected with respective front and rear radius arms.

FIG. 10C is a perspective view from above and in front of the medial side (inside) of the chassis with radius arms of FIG. 10A, showing the front (on the lower left hand side) and rear (on the upper right hand side) axles connected with respective front and rear radius arms.

FIG. 10D is a perspective view from below and in front of the medial side (inside) of the chassis with radius arms of FIG. 10A, showing the front (on the upper left hand side) and rear (on the lower right hand side) axles connected with respective front and rear radius arms.

FIG. 10E is a perspective view from further above FIG. 10C and in front of the medial side (inside) of a frame rail, showing the front (on the lower left hand side) and rear (on the upper right hand side) axles connected with respective front and rear radius arms.

FIG. 10F is a plan view of the bottom side of the chassis with radius arms of FIG. 10A, showing the front (on the left hand side) and rear (on the right hand side) axles connected with respective front and rear radius arms.

FIG. 10G is a plan view of the front of the chassis with radius arms of FIG. 10A, showing the front axle connected with one of the front radius arms mounted to one of the two radial sections.

FIG. 10H is a perspective view from above and to the rear passenger side of the distal side (outside) of the chassis with radius arms of FIG. 10A, showing the front (on the upper right hand side) and rear axles (on the lower left hand side) connected with respective front and rear radius arms.

FIG. 11 is a perspective view from above and to the rear passenger side of the distal side (outside) of the chassis with radius arms of FIG. 10H, showing the detailed mounting of the rear axle via the rear radius arm to the frame.

FIG. 12A is a plan view of the distal side (outside) of a chassis with radius arms, showing the front (on the right hand side) and rear (on the left hand side) axles connected with respective front and rear radius arms.

FIG. 12B is a plan view of the medial side (inside) of the chassis with radius arms of FIG. 12A, showing the front (on the left hand side) and rear (on the right hand side) axles connected with respective front and rear radius arms.

FIG. 12C is a perspective view from above and to the front driver side of the distal side (outside) of the chassis with radius arms of FIG. 12A, showing the front (on the lower left hand side) and rear (on the upper right hand side) axles connected with respective front and rear radius arms.

FIG. 12D is a perspective view from below and in front of the medial side (inside) of the chassis with radius arms of FIG. 12A, showing the front (on the upper left hand side) and rear (on the lower right hand side) axles connected with respective front and rear radius arms.

FIG. 12E is a perspective view from further above FIG. 12C and in front of the medial side (inside) of a frame rail, showing the front (on the lower left hand side) and rear (on the upper right hand side) axles connected with respective front and rear radius arms.

FIG. 12F is a plan view of the bottom side of chassis with radius arms of FIG. 12A, showing the front (on the left hand side) and rear (on the right hand side) axles connected with respective front and rear radius arms.

FIG. 12G is a plan view of the front of the chassis with radius arms of FIG. 12A, showing the front axle connected with one of the front radius arms mounted to one of the two radial sections.

FIG. 12H is a perspective view from above FIG. 12C and to the rear passenger side of the distal side (outside) of chassis with radius arms of FIG. 12A, showing the front (on the upper right hand side) and rear axles (on the lower left hand side) connected with respective front and rear radius arms.

### DETAILED DESCRIPTION OF THE INVENTION

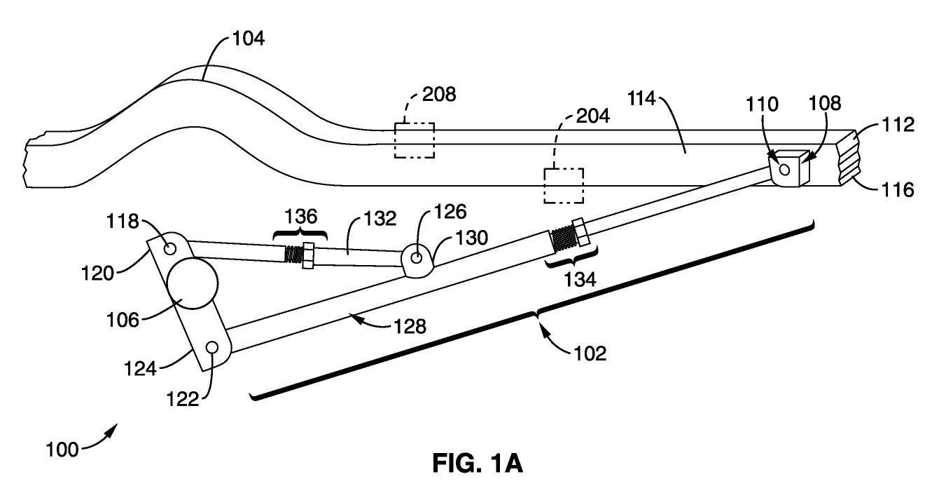

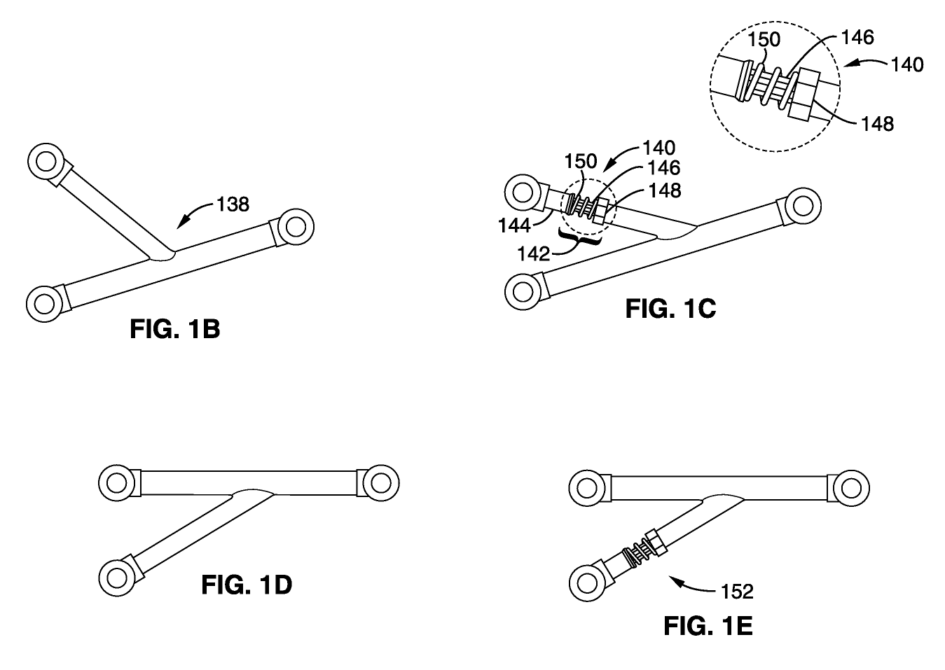

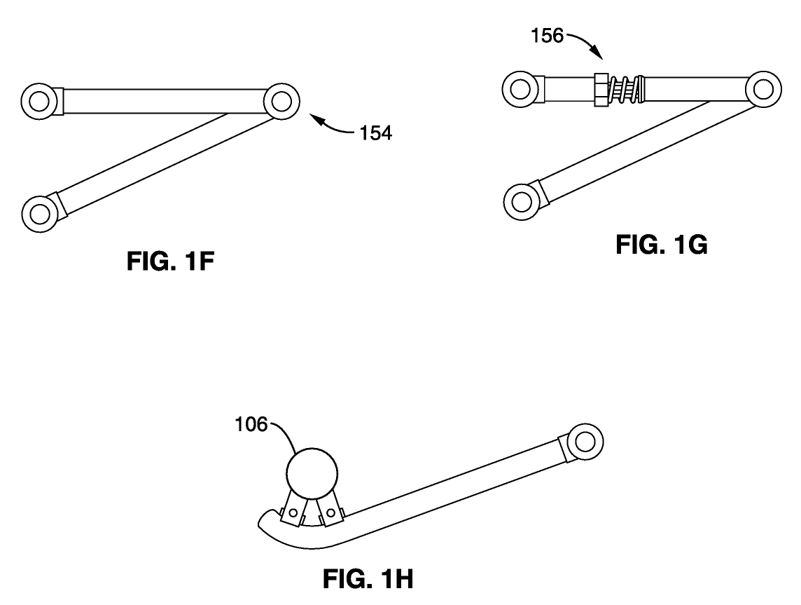

Referring more specifically to the drawings, for illustrative purposes the present invention is embodied in the apparatus generally shown in FIG. 1 through FIG. 11F. It will be appreciated that the apparatus may vary as to configuration and as to details of the parts, and that the method may vary as to the specific steps and sequence, without departing from the basic concepts as disclosed herein.

Lifting

In off road motorized sports, a frequent object is to be able to take a vehicle over increasingly rugged terrain. Even though factory off highway vehicles (OHVs) are designed and sold with some degree of off road capability, the aftermarket manufacturer is attempting to make the vehicle perform with higher capability off road, while retaining the comfort and handling characteristics of highway driving. Thus, the factory configuration of the vehicle chassis is perhaps not sufficiently high to clear particularly difficult rock climbing terrain, such as the Rubicon Trail.

The Rubicon trail is also known as the McKinney-Rubicon Springs Road, which is located in the California High Sierras due west of Lake Tahoe. This particular trail is rated as a “10” as being “most difficult” on a scale of 1-10. It is referred to as the “Granddaddy of all off highway trails” it is about. 12 miles of incredibly scenic but extremely challenging rocky road.

In order to successfully challenge such difficult trails, where rocks are strewn across the trail to heights of three feet or more, one attempts to raise the chassis of their OHV every little bit in order to gain more clearance. This process of raising the chassis (which is basically everything above the wheels) is referred to as “lifting”. “Ordinary” lifts are perhaps 2.5″ to 4″, with lifts exceeding 10″ not infrequent.

There are at least two major difficulties that accompany lifting: 1) vehicle handling deteriorates markedly, and 2) the factory designed drive train (everything from the transmission or transfer case to the axles) are sufficiently changed so as to engender excessive drive-train-induced vibrations as well as exceed the allowable design departure angles (angles of bend in the joint) of various U-joints, constant velocity joints, and the like.

One aspect of this invention seeks to ameliorate or eliminate the various limitations that result from the practice of lifting, whether done at a factory, or done as an aftermarket modification. This will be further described below.

Rear Axle Radius Arm

Refer now to FIG. 1A, which is a side view 100 of one embodiment of a rear axle radius arm 102. Here we see a cutaway portion of a vehicle frame 104. The vehicle may be an automobile, a truck, or an off road capable vehicle. The rear axle radius arm 102 provides a rotational connection between the frame 104 and the rear axle 106. The rear axle 106 is normally operation at the back, or rear, end of the vehicle.

A bracket 108 is attached to the frame 104. The bracket 108 provides a rotational attachment point for the rear axle radius arm 102 through a movable joint 110, which may either be principally a rotational with a small amount of spherical compliance, or a more preferably a spherical joint that has at least a portion of its range of mobility capable of spherical rotation.

The frame 104 has a side closer to a front-to-back medial plane of substantial symmetry (not shown) in the vehicle (known as a medial side 112), a further away side (known as a distal side 114) from the medial plane than the medial side 112, a bottom side 116, and the radius arm 102 that is movably attached to the bracket 108, wherein the radius arm 102 movably connects the rear axle 106 to the bracket 108.

The rear axle radius arm 102 constrains movement of the rear axle 106 relative to the radius arm 102 through the movable joint 108 that connects to the frame 104, a first compliant pivot 118 (hereafter referred to for convenience as the upper compliant pivot 118 without loss of generality) that attaches to a first mount 120 (hereafter referred to for convenience as the upper mount 120 without loss of generality) on the rear axle 106, a second compliant pivot 122 (hereafter referred to for convenience as the lower compliant pivot 122 without loss of generality) that attaches to a second mount 124 (hereafter referred to for convenience as the lower mount 124 without loss of generality) on the rear axle 106; and an intermediate compliant pivot 126 disposed between the movable joint 110 and the second compliant pivot 122, where the pivot 126 attached to the lower control arm 128.

The movable joint 110 is preferably a spherical joint, allowing a spherical range of motion within a limited solid angle of motion for rear axle 106 strokes and articulation.

The upper 120 and lower 124 mount designations are merely used here as a convenience in referring to the drawings, as the upper and lower positions may be rotated about the rear axle 106 as design needs dictate, so long as the functionality of the radius arm 102 is not compromised. Thus, they may be move to less than opposing angles, be made parallel to the ground, or otherwise located. Additionally, FIG. 1A indicates a side view of the rear axle 106, where the axial disposition of the upper mount 120 and the lower mount 124 along the axle is unknown (due to FIG. 1A being a side view). Thus, the upper mount 120 and lower mount 124 may be vertically disposed one above the other, or they may be spaced apart relative to a vertical plane.

It should be pointed out in particular that these upper 120 and lower 124 mounts may in fact be factory mounts that originally were used for rear axle connection to other suspension components. Alternatively, the mounts may be generic to a specific rear axle build. Still another option would be that the rear axle mounts were specially fabricated for one of the rear radius links disclosed here. Regardless of the purpose or origin, the mounts may be used for attachment to some form of the rear radius arm disclosed herein.

Nowhere in this application is a limitation required where a mount serves only as a suspension mounting location for rear radius arms; they may additionally be mounts for shock absorbers, brake lines, or other components conveniently attached to a mount. The only restriction would be that the mount would allow movement of the rear radius arm within its envelope of operation without interference with other components.

The rear axle radius arm 102 may comprise: a lower control arm 128 that comprises: (1) a lower compliant pivot 122 that connects to a lower mount 124 on the rear axle 106 at one end; and (2) a movable joint 110 that connects to the bracket 108 located on the frame 104 at the other end; and (3) an upper control arm bracket 130 located between the lower compliant pivot 122 and the movable joint 110, on lower control arm 128; and an upper control arm 132 that comprises: (1) an upper compliant pivot 118 that connects to an upper mount 120 on the rear axle 106 at one end, and (2) an intermediate compliant pivot 126 that connects to the lower control arm 128 at the upper control arm bracket 130.

The lower control arm 128 may have a lower control arm length adjustment 134. Similarly, the upper control arm 132 may have an upper control arm length adjustment 136. These length adjustments are made to correctly position the rear axle 106 to a specific location and angle of inclination relative to the frame 104, as well as a position the rear axle 106 substantially orthogonally to a vertical plane that passes through the front-to-back medial plane of substantial symmetry (not shown) in the vehicle. The rear axle 106 may additionally be correctly positioned relative to a drive shaft and rotational power source, as further described below.

The rear axle radius arm 102 may be disposed as one rear axle radius arm 102 on each side of the medial plane of the automobile. A line may be drawn between the centers of the two rear axle radius arms 102 movable joints 110 to form a center of rear suspension rotation. The rear axle radius arms 102 disposed as above on each side of the medial plane may be substantially mirror images of each other, or may otherwise be identical, depending on the application. This center of rear suspension rotation may alternatively be drawn between the two brackets 108 attached to the frame 104.

An even simpler implementation occurs when the rear axle 106 is just a free wheeling (i.e. undriven) rear axle 106 in a front wheel drive vehicle, in which case there is no differential, and no drive shaft connection to the rear axle 106.

Refer now to FIG. 1A, and FIGS. 1B-1H. FIGS. 1B-1H are other variations on rear axle radius arms.

In FIG. 1B, the upper control arm and lower control arm are similar to those in FIG. 1A, without the intermediate compliant pivot 126 of FIG. 1A. Instead, a substantially rigid connection 138 connects the upper control arm and lower control arm. Here, axle articulation may be accomplished by greater flexural deformations of the remaining pivots, or through bending of the control arms.

In FIG. 1C, the same geometry of FIG. 1B is seen, with an axial length adjustment 140 present in the upper control arm. The axial length adjustment 140 may be rigid, as in an adjustable suspension component, or may slide with a spring force returning the upper control arm to a force balancing state.

One implementation of the sliding upper control arm is shown in inset 142, where a threaded portion 144 allows for an initial length adjustment, and a spline 146 slides into a receiving spline 148, surrounded by a helical or other type spring 150. The sliding action of the spline 146 allows for axle stroke FIG. 1D is similar to FIG. 1B, however, in FIG. 1D, the upper control link is longer, and the lower control link is short.

FIG. 1E takes the geometry of FIG. 1D, and allows for the adjustment of length 152, either as an initial length set, or as an initial length set with a compliant length as previously described in inset 142.

FIG. 1F is a rear radius arm, with a fixed upper and lower control arm pivoting about a single pivot point 154.

FIG. 1G is the rear radius arm of FIG. 1F, that allows for the adjustment of length 156, either as an initial length set, or as an initial length set with a compliant length as previously described in inset 142.

FIG. 1H is a side view of one embodiment of a rear axle radius arm, where a single control arm connects at the rear axle 106 with two pivot points, and at the frame with a single pivot point. The two point connection to the rear axle allows for a bending moment to be transferred to the single control arm. The bending moment causes flexural deformation of the control arm, allowing for rear axle articulation.

In all of the rear axle radius arm implementations of FIGS. 1A-1H, fixed length adjustments may or may not be incorporated into the upper or lower control arms to allow for initial axle to frame adjustments.

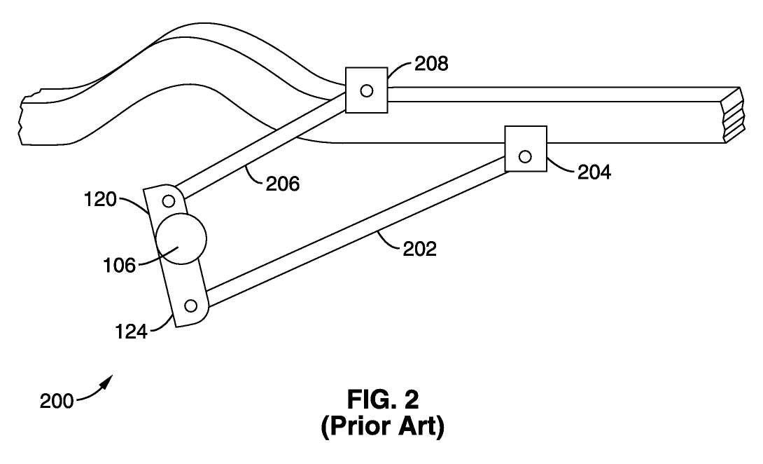

Refer now to FIG. 2, which is a cross sectional view 200 of a factory-supplied (PRIOR ART) rear axle 106 configuration. Here, the lower mount 124 is attached to a rear lower control arm 202, which in turn attaches to a lower frame bracket 204. Similarly, the upper mount 120 on the rear axle 106 is attached to a factory installed rear upper control arm 206, which is in turn attached to an upper frame bracket 208. This FIG. 2 view is taken from a plane of substantial symmetry of the vehicle looking out. Thus, the upper mount 208 and lower mount 204 are on the medial side of the frame 104.

Referring back to FIG. 1, it is noted that the upper frame bracket 208 and lower frame bracket 204 are shown as dashed structures, as they are either not used, or completely removed from the frame 104 when the rear axle radius arm 102 is installed as a retrofit.

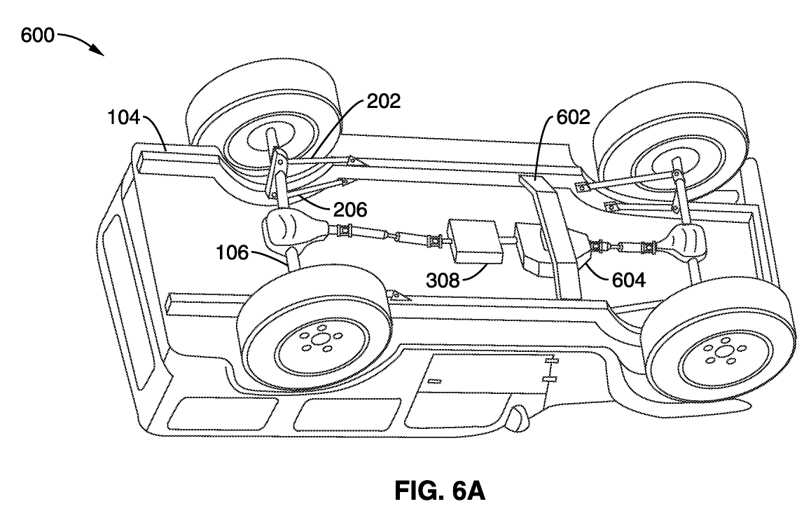

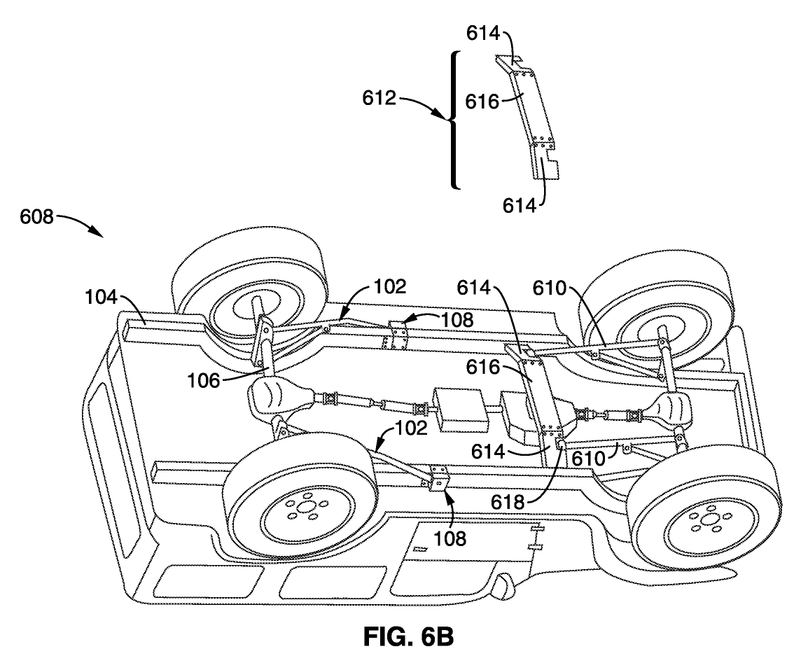

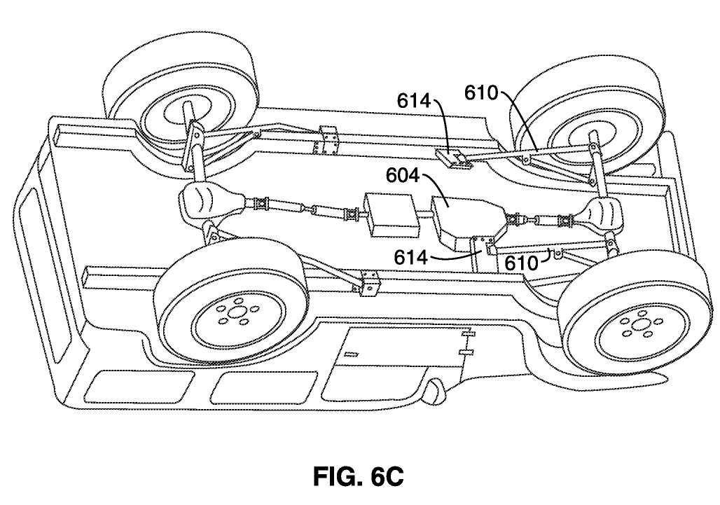

Comparing FIG. 1 and FIG. 2, it appears that in the prior art of FIG. 2, the bracket 108 that provides a mount for the rear axle radius arm 102 is missing. Thus, the bracket 108 may be installed as an aftermarket bracket attached to the frame 104. The bracket may be attached to the distal side of the frame, the medial side of the frame, or attached to the bottom side of the frame. Shown in subsequent FIG. 6 will be alternative structures that span between two frames, providing an attachment point equivalent to the bracket 108 that may be some distance medially away from the frame 104.

### Drive Train Modifications

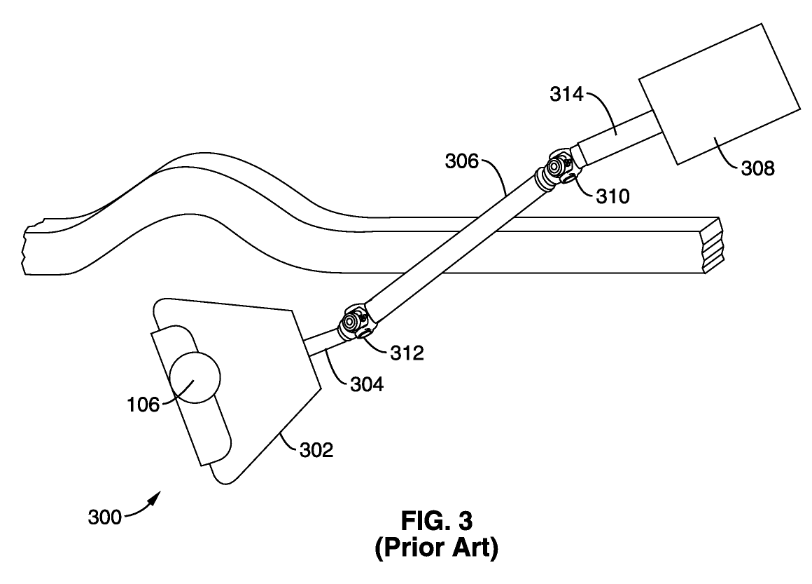

Refer now to FIG. 3, which is a side view of a factory drive train 300. Here, the rear axle 106 is now shown with a differential housing 302 that projects therefrom. Typically, a pinion 304 (that exits the differential housing 302) attaches to drive shaft 306 and then the rotational power source 308. The interconnection between the drive shaft 306 and the rotational power source 308 may be a U-joint 310. The interconnection between the drive shaft 306 and the pinion 304 is with another matched U-joint 312. Ideally, the angle of declination of the rotational power source 308 output shaft 314 is the same as the angle of inclination of the pinion 304. When the angles of inclination and declination are so matched, then the U-joint pair 310 and 312 provides constant rotational velocities of the pinion 304 relative to the output shaft 314.

However, even if the rotational velocity of the pinion 304 relative to the output shaft 314 is constant, the drive shaft 306, of non-negligible rotational inertia, will undergo sinusoidally varying rotational rates during every revolution simply as a consequence of the rotational linkage between two U-joints. To a person occupying the vehicle driven by the drive shaft 306, this is experienced as a drive shaft 306 induced vibration. This induced vibration is typically managed by replacing U-joints 310 and 312 with constant velocity joints (CV-joints).

Further, in FIG. 3, the ideal situation of a matched angle of inclination and angle of declination are shown in their resting configurations. In typical four-wheeled operation of an off highway vehicle (OHV), the rear axle 106 may travel through strokes (ranges of motion) on the order of 10 inches (25.4 cm). Given that drive shafts may be as short as 17 inches, the angle of declination and inclination may vary wildly, leading to gross angular mismatches.

When the double U-joint has differing angles of declination and inclination, a sinusoidal surging through each revolution is transmitted to the rear axle 106. This is another reason that the auto industry has adopted the utilization of constant velocity (CV) joints instead of the U-joints of former years.

Even traditional CV joints have difficulties with accommodating the geometries of an OHV, where the drive train may experience extreme angle changes that bend into a very acute geometry. Even when CV-joints replace the U-joints 310 and 312, disparate inclination and declination angles cause phasing errors that result in surging vibrations originating in the drive shaft 306 and rear axle 106. One solution to this is described below.

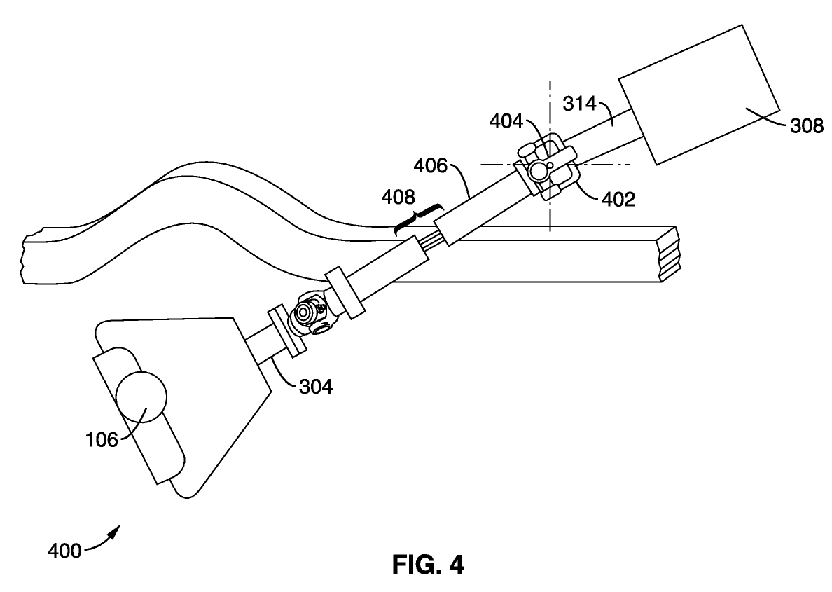

Refer now to FIG. 4, which is a side view of an aftermarket drive train modification 400. Here, the rear axle 106 is tilted so that a central axis of the pinion 304 intersects the center of rotation of a double Cardan joint 402. Ideally the pinion 304 axis substantially intersects the center of rear suspension rotation 404. Here, the double Cardan joint 402 is connected at one end to a drive shaft 406 that connects the differential pinion 304, and at the other end to the output shaft 314 of a rotational power source 308. The rotational power source may comprise ether a transfer case or a transmission or other source of rotational power, such as an electric motor. To accommodate rear axle 106 movement due to the sweeping motion of the rear axle 106 moving under constraint of the rear axle radius arm 102 (not shown here for clarity), the drive shaft 406 has an extendable region 408 that allows for axial movement of the drive shaft 406 to prevent axle binding that might otherwise occur.

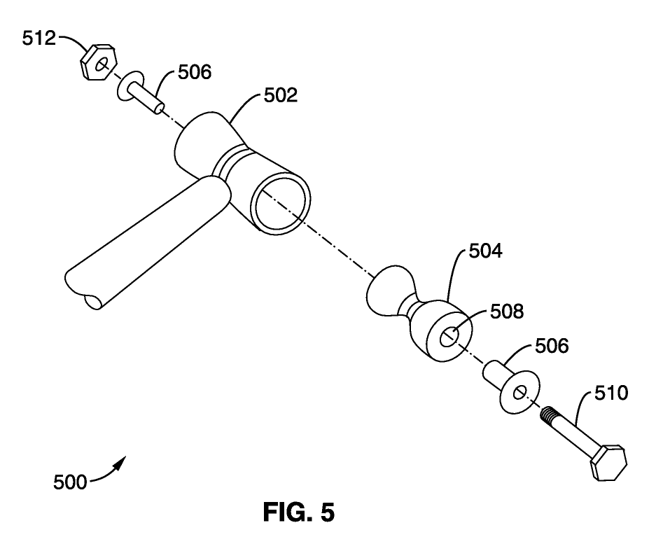

Refer now to FIG. 5, which is a detailed assembly view of the compliant pivot 500 used in the upper compliant pivot 118, the intermediate compliant pivot 126, and the lower compliant pivot 122 previously presented in FIGS. 1A-1H. The upper compliant pivot 118, the intermediate compliant pivot 126, and the lower compliant pivot 122, all allow for both rotational and a restrained degree of tilt outside of their normal axes of rotation. The restrained degree of tilt allows the rear axle 106 to articulate, where one wheel is high than the other.

The compliant pivots 500 may each comprise: a housing 502; a thick-walled tubular compliant bushing 504 assembled and disposed within the housing 502; two metal caps 506 that protrude into the inner diameter 508 of the tubular compliant bushing 504 that allows for a passage of a central shaft 510 into a nut 512, wherein the housing 502 and caps 506 limit translational movement of the central shaft 510 within the housing 502 through constrained deformation of the tubular compliant bushing 504.

The thick-walled tubular compliant bushing 504 may be comprised of a compliant material, such as a 75 durometer nitrile-butadiene rubber (NBR) or other such compliant material. Each of the bushings may have a different size and durometer, as optimized by vehicle dynamic modeling codes, as well as actual on and off road performance testing.

### EXAMPLE 1

### A First Off Road Vehicle Modification

A first example of the underbody of a first representative off road vehicle is modified in FIGS. 6A-6C.

### Factory Four Wheel Drive Vehicle

Refer now to FIG. 6A, which is a perspective view of the underside of a typical factory four wheel drive vehicle suitable for off road use 600. A cross member 602 may or may not be present. The cross member 602 may act to protect other underbody components from off road damage. The cross member 602 may support other components, such as a transfer case 308 or a transmission 602. A transfer case 308 operates in a four wheel drive to provide motive power to both the front and rear wheels when so selected.

The cross member 602 traditionally provides support to the transmission 604. The cross member 602 is suitable for aftermarket modifications as explained further below.

In the factory configuration, the rear axle 106 is supported by the rear lower control arm 202 and the rear upper control arm 206 that both medially attach to the frame 104.

### Rear Axle Radius Arm Replacement

Refer now to FIG. 6B, which is a perspective view of the underside of a typical factory four wheel drive vehicle suitable for off road use of FIG. 6A that has been modified 608 to include a rear axle radius arm 102. Here, the rear axle 106 is connected to the frame 104 by use of the rear axle radius arm 102, which is distally mounted to the frame 104 by bracket 108. The distal mount is particularly useful when the factory vehicle has components (typically gas tanks) that would otherwise interfere with a medial rear axle radius arm mount.

### Front Radius Arm and Transmission Mount

Also shown in FIG. 6B is a modification allowing mounting of front radius arms 610 off pivotally mounted to a modified transmission mount 612. The modified transmission mount 612 has two radial sections 614 and a central section 616. The radial sections 614 each have provisions 618 for optionally attaching front radius arms 610 as a retrofit.

Refer now to FIG. 6C, which is a perspective view of the underside of a modified factory four wheel drive vehicle suitable for off road use of FIG. 6B, with the same front radius arm and transmission mount modifications, but with the central section 616 of the modified transmission mount 612 removed. By removing the central section 616, the transmission 604 is readily accessed. Additionally, any initial adjustments of the front radius arms 610 remains intact since the radial sections 614 of the modified transmission mount 612 remain unmoved.

Removal of the central section 616 may allow access to other underbody components that may otherwise be quite inaccessible.

### EXAMPLE 2

### A Second Off Road Vehicle Modification

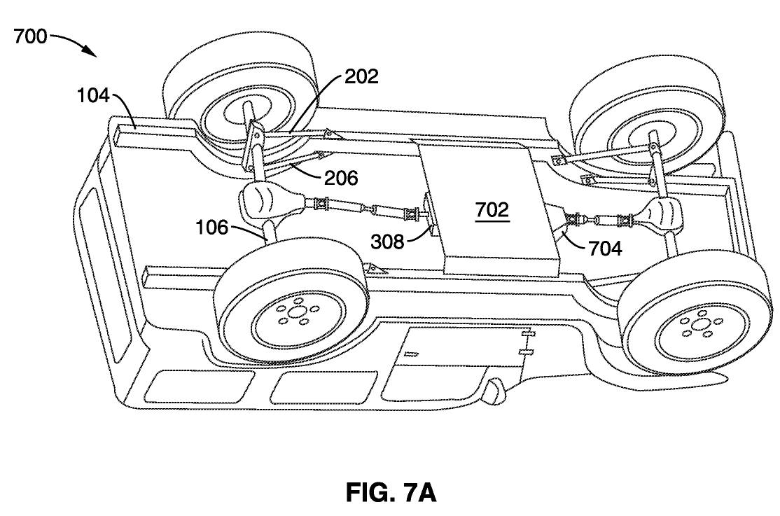

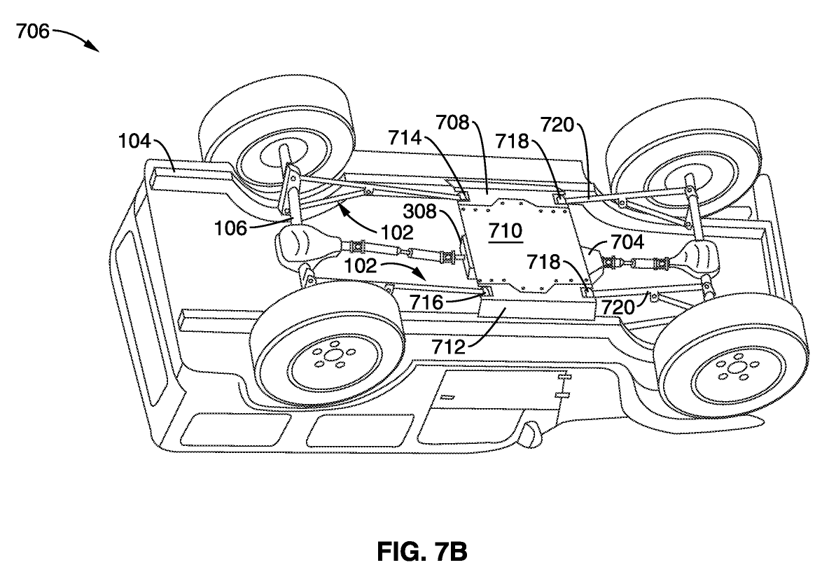

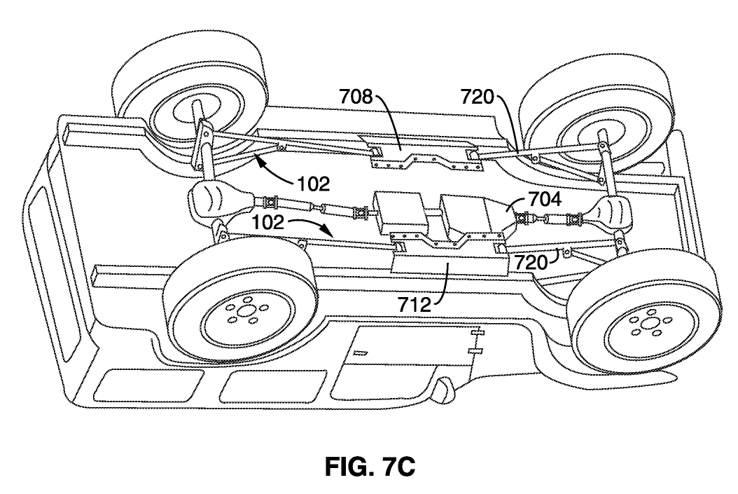

A second example of the underbody of a second representative off road vehicle is modified in FIGS. 7A-7C.

### Factory Four Wheel Drive Vehicle

Refer now to FIG. 7A, which is a perspective view of the underside of a typical factory four wheel drive vehicle suitable for off road use 700. A cross member shield 702 may or may not be present. The cross member 702 may act to protect other underbody components from off road damage. The cross member 702 may support other components, such as a transfer case 308 or a transmission 704. A transfer case 308 operates in a four wheel drive to provide motive power to both the front and rear wheels when so selected.

The cross member shield 702 traditionally provides support to the transmission 704. The cross member 702 is suitable for aftermarket modifications as explained further below.

In the factory configuration, the rear axle 106 is supported by the rear lower control arm 202 and the rear upper control arm 206 that both medially attach to the frame 104.

### Rear Axle Radius Arm Replacement

Refer now to FIG. 7B, which is a perspective view of the underside of a typical factory four wheel drive vehicle suitable for off road use of FIG. 7A that has been modified with an aftermarket transmission and radius arm mount 706 to include rear axle radius arms 102. Here, the rear axle 106 is connected to the frame 104 by use of the rear axle radius arm 102. The rear axle radius arms 102 may be distally mounted to the frame 104 as previously described in FIGS. 6B and 6C. Instead of direction mounting to the frame 104, an alternative mounting location is used.

### Alternate Rear Axle Radius Arm Mounting Locations

Referring again to FIG. 7B, the drive train comprises a transmission 704 supported by an aftermarket transmission and radius arm mount 706 comprising a first lateral support 708, a removable enter section 710, and a second lateral support 712. The aftermarket transmission and radius arm mount 706 is comprised of a first lateral support 708 that connects on one side to the frame 104 on one side of the chassis, and on the other side to the removable center section 710. The removable center section 710 continues to mount on its other side to a second lateral support 712, which attaches to the frame 104 on the other side of the chassis. The transfer case 308 may be removably supported by the removable center section 710.

The first lateral support 708 comprises a first pivot mount 714 that provides a pivotal support to the rear axle radius arm 102. The first pivot mount 714 may either be an integral component of the first lateral support 708, or may be removably attached. Similarly, the second pivot mount 716 may either be an integral component of the second lateral support 712, or may be removably attached. Generally, both pivot mounts would be either integral or attached, but would unlikely be one of each.

The removable center section 710 may be detached from the first lateral support 708 and the second lateral support 712, and may also support either a transmission 704 or transfer case 308. When servicing of the transfer case 308, or other supported component (not shown), the transfer case 308 may be removed along with the removable center section 710. It should be noted that removal and replacement of the removable center section 710 and transfer case 308 does not require realignment of the rear axle radius arms 102.

The removability of the center support section 710 allows for the servicing of driveline components (transmission 704 or transfer case 308) without the additional labor required to remove and replace the rear axle radius arms 102, followed by an entire rear end alignment due to suspension dimensional changes in the mounting of the rear axle radius arms 102.

The aftermarket transmission and radius arm mount 706 (comprised of the first lateral support 708, the center support 710, and the second lateral support 712) may additionally have strengthening gussets (not shown for clarity, but in reality such gussets could be both in front and back of the radius arm mounts, and on both driver and passenger sides of the vehicle) that increase the overall strength of the aftermarket transmission and front radius arm mount 706, stiffen the vehicle frame 104, and additionally provide an extremely rugged shield for rock scraping in challenging off road rock climbing and bouldering activities.

Similar to the mounting locations 716 for the rear radius arms 102, there may be front radius arm mounts 718 for mounting of front radius arms 720. Again, removal of the removable center section 710 allows for work to be done beneath the center section 710 without consequent realignment of the rear axle radius arms 102 or front radius arms 720.

The aftermarket transmission and radius arm mount 706 is useful even when the frame 104 is accessible for mounting the rear axle radius arms 102, because the mount and shield allows for the rear axle radius arm 102 mounts 714 and 716 to be shifted significantly forward. In vehicle handling characteristics, even a one or two inch shift forward lengthens the effective wheel base of the rear axle, in many cases dramatically improving handling characteristics. Here, the mount and shield may be moved far forward. The resultant dual radius arms and transmission mount would allow for frame 104 stiffening, as well as the opportunity for very long radius arm lengths.

### Removal of Central Section

Refer now to FIG. 7C, which is a perspective view of the underside of the modified factory four wheel drive vehicle suitable for off road use of FIG. 7B, with the same front and rear radius arms and transmission mount modifications, but with the central section 710 that supports the transmission 704 removed. By removing the central section 710, the transmission 704 is readily accessed. Additionally, any initial adjustments of the front radius arms 720 remains intact since the radial sections 708 and 712 of the aftermarket transmission and radius arm mount 706 remain unmoved.

Removal of the central section 710 may allow access to other underbody components that may otherwise be quite inaccessible.

### Radius Arm Mounting Bracket

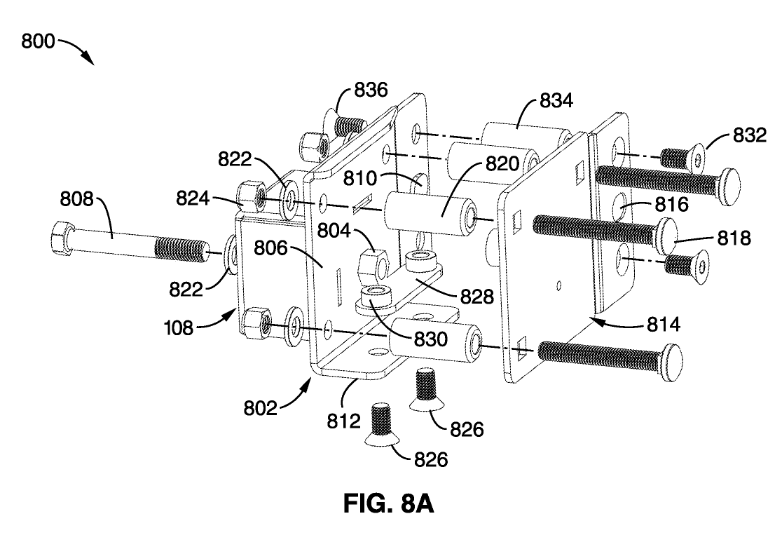

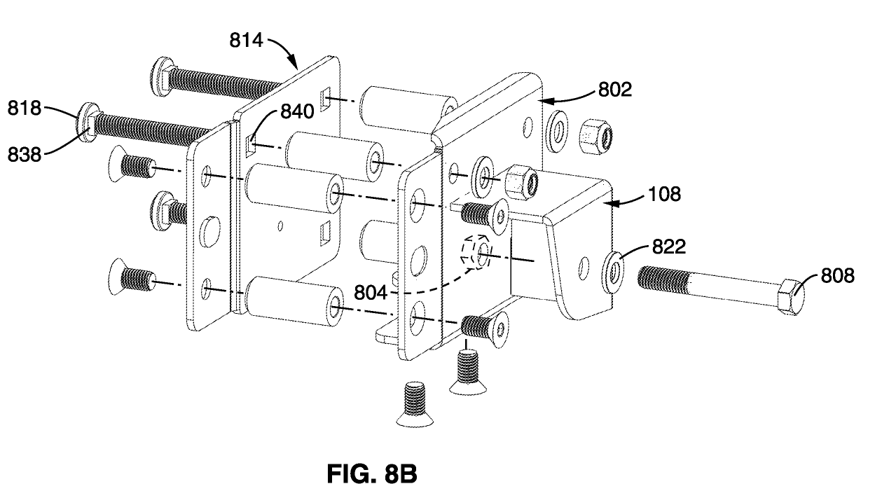

Refer now to FIG. 8A, which are implementations 800 of a radius arm mounting bracket 108 previously discussed. Here a cuff 802 component partially wraps around a factory frame 104 (not shown here). A nut 804 is welded to an inner face 806 of the cuff 802. The welded nut 804 allows for a radius arm pivot bolt 808 to be blindly inserted and tightened, which would otherwise be quite a difficult, if not impossible task.

A precision semi-pierced geometric feature 810 aligns with matching precision points on the frame 104 (again not shown), and will vary in geometry depending on the geometry of the precision points on the frame 104. A lower lip 812 folds under the cuff 802 to better distribute loads to the frame 104 without undue concentrations of stress leading to premature fatigue and breakage of either the frame 104 or the mount 800.

A doubler plate 814 additionally assists in mounting to the frame 104. Another semi-pierced precision feature 816 allows for precise locating of the doubler plate 814. Both this feature 816 and the previously discussed feature 810 may either be in fact semi-pierced, or may be completely punched, and replaced and welded into a semi-pierced position. Such a weld semi-pierced feature is in fact much stronger than a strictly punched semi-pierced feature, and results in a much more reliable feature.

A plurality of high strength carriage bolts 818 pass through the double plate 814, into a cylindrical spacer 820, through the cuff 802, and into a lock washer 822 and finally a nut 824. The cylindrical spacer 820 may either be treaded to engage the bolt 818, or may permit passage of the bolt 818 without treaded engagement.

Additional flat head screws 826 are countersunk into the lower lip 812, and pass through the lower lip 812, through a clearance hole in the frame 104, and are secured by a plate 828 that has PEM or other such fasteners 830 attached thereto. As the plate 828 is fixed into place within the hollow rectangular beam that comprises the frame 104, it is passed from a convenient place outside the frame, and pulled into position so as to align with the plurality of flat head screws 826. This may be simply accomplished by bending a piece of wire to pass within the threaded diameter of the fastener 830.

Additional flat head screws 832 pass through the doubler plate 814 to be threaded into cylindrical spacer 834, which in this case is threaded to receive the flat head screws 832. On the other side of the cylindrical spacer 834, another set of flat head screws 836 pass through the cuff 802, through a clearance hole in the frame 104, and finally threads into the cylindrical spacer 834.

Refer now to FIG. 8B, which is a perspective view of the other side of the radius arm mounting bracket 108 previously discussed in FIG. 8A. Here, it is easier to discern that the high strength carriage bolts 818 have a square neck 838 to engage with a matching square opening 840 in the doubler plate 814. Thus, there is no tool required to be placed on the head of the high strength carriage bolts 818.

This view more clearly points out the radius arm bracket 108, which is welded to the cuff 802. Radius arm pivot bolt 808 is seen to pass through the bracket 108, and secures onto the welded nut 804 (shown here in dashes, as it is hidden in this view).

All components of the bracket 108, cuff 802, and doubler plate 814, and miscellaneous hardware are steel or other high-strength material, suitable for the loads being placed upon them by the radius arm (not shown), as applied through the radius arm pivot bolt 808.

Lower Control Arm Section of Rear Radius Arm

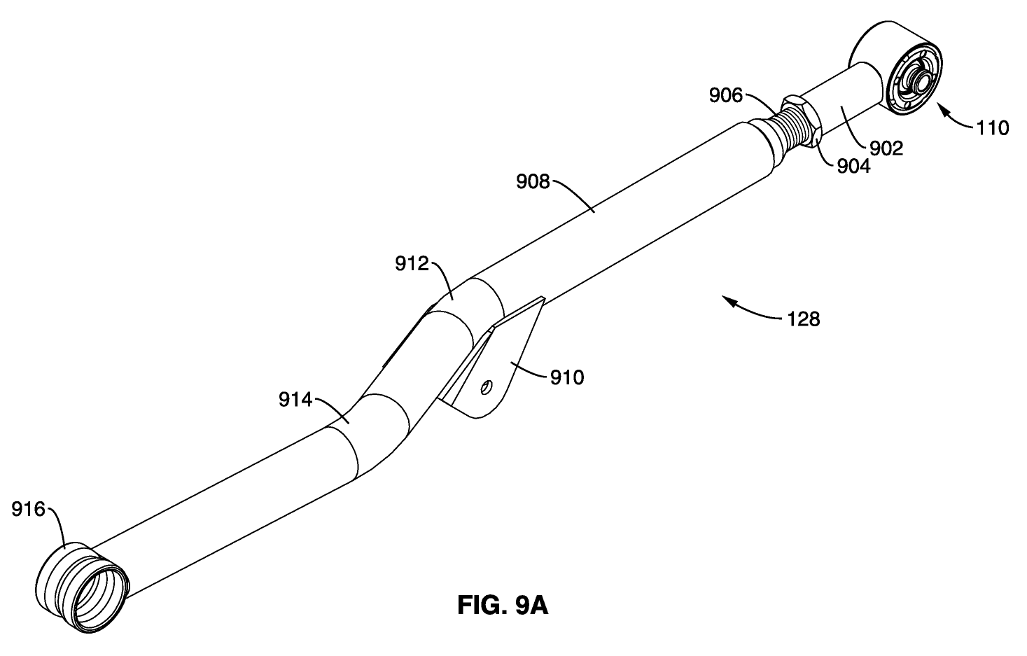

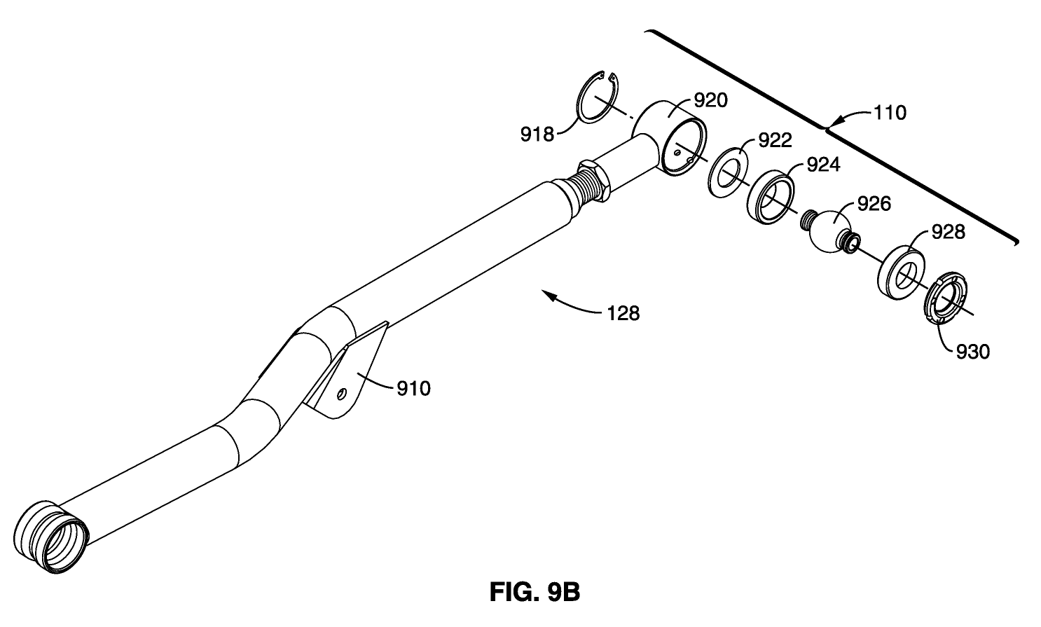

Refer now to FIG. 9A, which is a perspective view of a lower control arm 128 within a rear radius arm in more detail. Here, a tubular shaft 900 attaches on one end to a movable joint 110. The movable joint 110 attaches to a neck 902, that has an appropriately sized bolt 904 welded to it. The welded bolt 904 has a shaft 906 treaded into it on one end, and is connected to the remainder of the control arm body 908 for length adjustment of the overall lower control arm 128.

An intermediate compliant pivot mount 910 is placed along the body 908, with bends 912 and 914 occurring as necessary to avoid other factory parts during the designed stroke and articulation of the rear axle 106 (not shown here).

Finally, at the terminal end of the control arm body 908, the lower compliant pivot housing 916 is placed.

Although the control arm body 908 is shown as tubular, it may be any suitable cross section, and may even be pieced together with one or more differing cross sections.

The treaded shaft 906 allows for lengthening or shortening the overall distance between the centers of the movable joint 110 and lower compliant pivot housing 916

Radius Arm Partial Spherical Pivot Refer now to FIG. 9B, which is an exploded view of the lower control arm 128 movable joint 110 that is used to attach to the frame 104 (not shown here). The movable joint 110 comprises several components.

First, a clip ring 918 is placed into a land (not shown) in the spherical housing 920 from one side of the spherical housing 920. Following the clip ring 918 installation, the following components are installed as a stacked from the side opposite that of the clip ring 918: a retention washer 922, a first spherical race 924, a partial spherical bearing 926 (partial due only limited range of motion in a spherical sense), a second spherical race 928 (that may be identical to the first spherical race 924), and finally a threaded adjustment retainer 930. When assembled as indicated, the inner diameters of the retention washer 922 and threaded adjustment retainer 930 place a limit the amount of spherical motion allowed to the spherical bearing 926. Any pivot shaft (not shown) passing through and attaching the partially spherical bearing 926 would also tend to limit the amount of spherical motion allowed by the rear axle radius arm (102 in FIG. 1) relative to its partially spherical bearing 926. The partially spherical bearing 926 is again denoted as such since typical motion allowed by a sphere is limited here by the attachment pivot shaft (not shown).

Further Chassis and Assembly Drawings

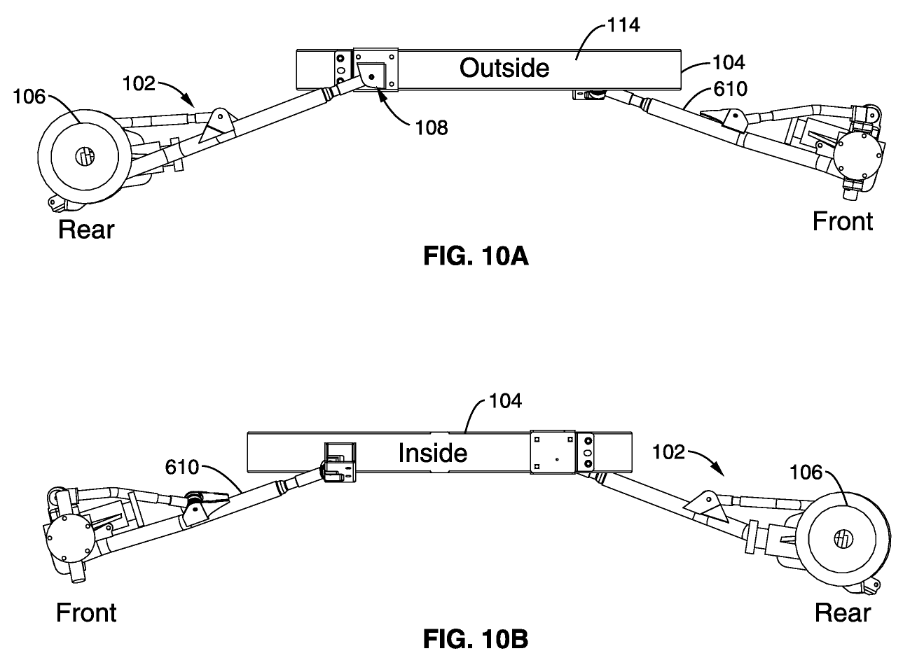

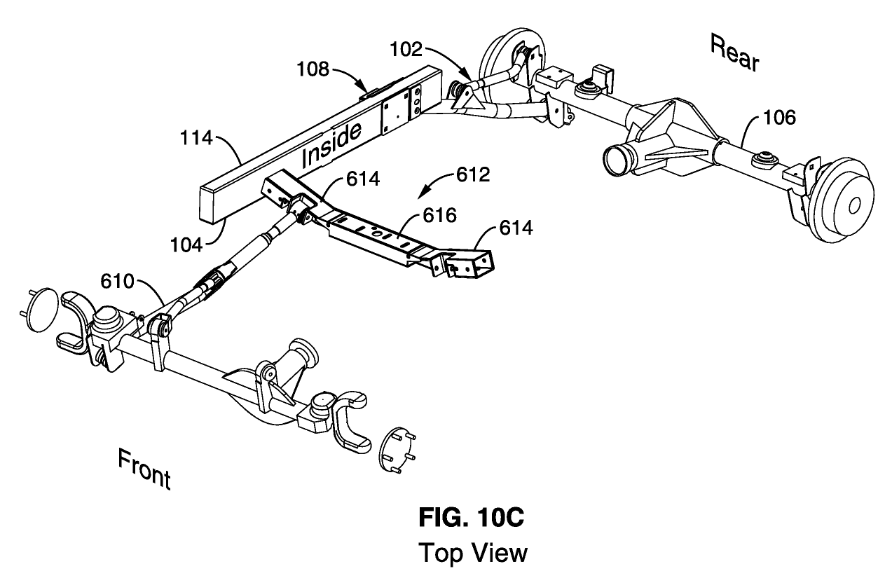

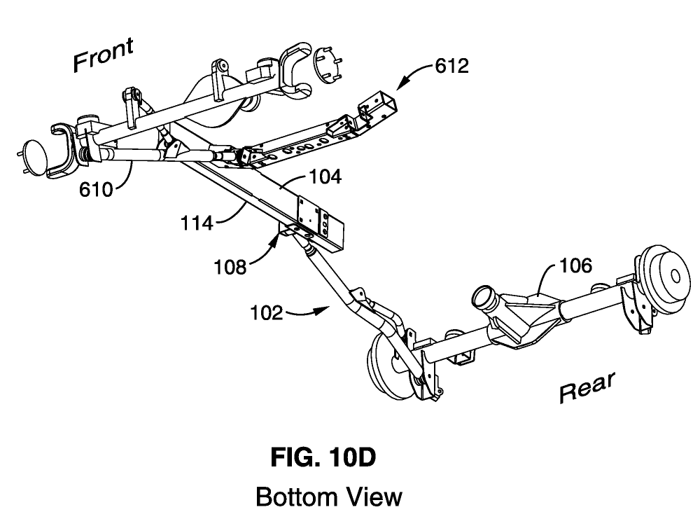

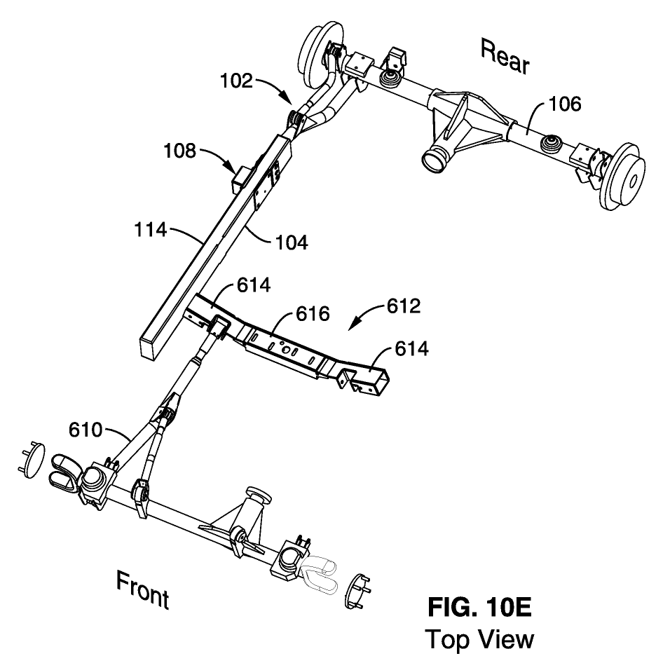

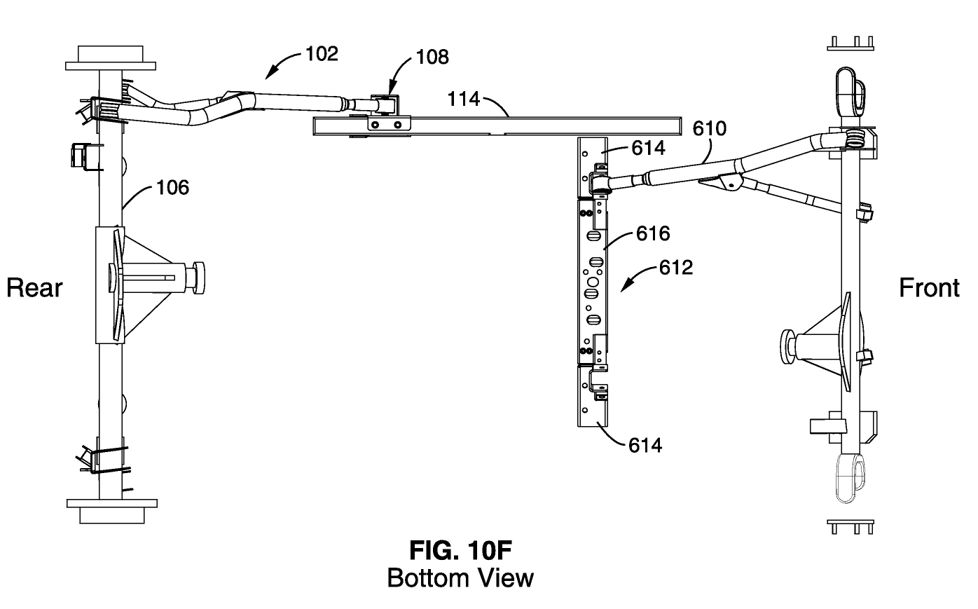

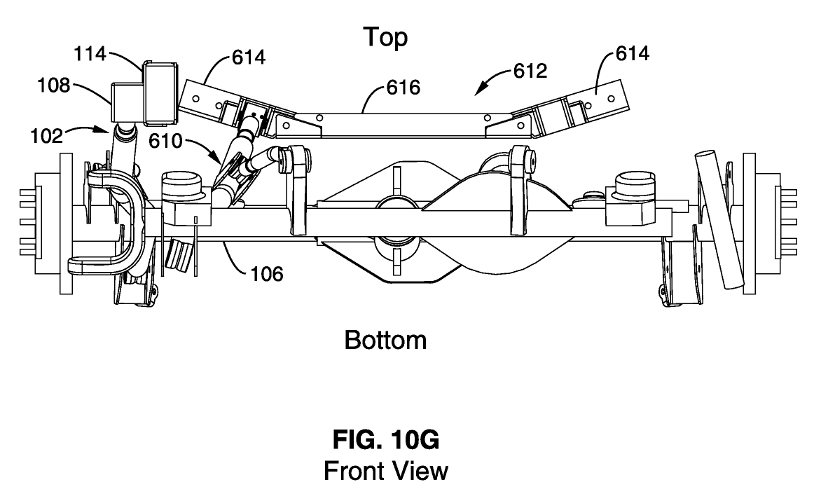

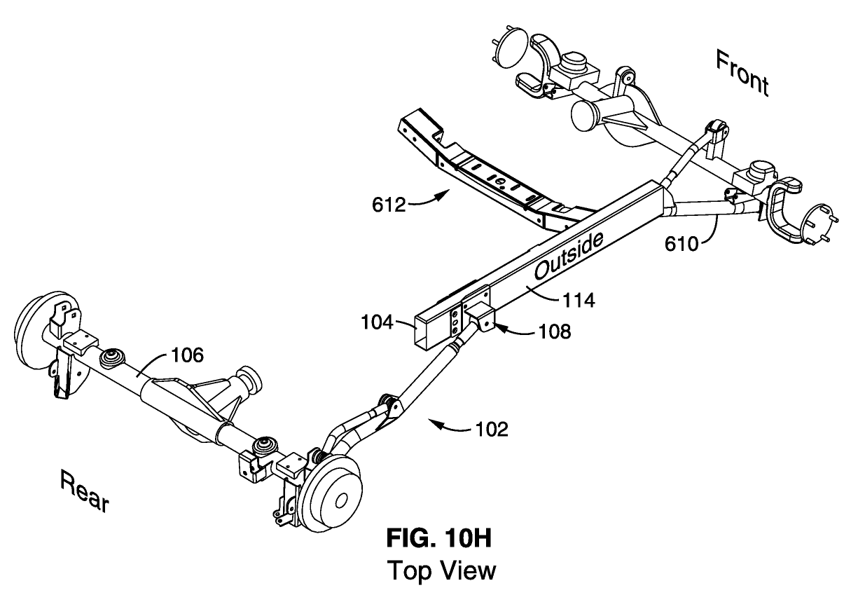

Refer now to FIGS. 10A-10H, which are various detailed views of the retrofit of the first type of off road vehicle shown previously in FIGS. 6A-6C, with aftermarket modifications made in FIGS. 6B and 6C. Various preceding figures are relied upon for the element numberings to minimize confusion.

For instance, FIG. 10A shows a plan view of the passenger side of the vehicle (in the US system with the driver on the left side). Here, the rear axle 106 is connected by a rear radius arm 102 to the frame 104 on the distal (outside) of the frame 114 through bracket 108. Additionally, a front radius arm 610 may also be attached to the same frame 104.

FIG. 10B shows the same elements covered in FIG. 1A, from the inside (medial aspect) of the frame 104. Here, the double plate 814 used for securing the bracket 108 to the frame 104 is evident.

FIG. 10C is a perspective view from above and in front of the medial side (inside) of the chassis with radius arms of FIG. 10A, showing the front (on the lower left hand side) and rear (on the upper right hand side) axles connected with respective front 610 and rear radius arms 102 connected to the frame 104. Here, well displayed in great detail, is the modified mount 612 comprising two radial sections 614 and the removable central section 604.

FIG. 10D is a perspective view from below and in front of the medial side (inside) of the chassis with radius arms of FIG. 10A, showing the front (on the upper left hand side) and rear (on the lower right hand side) axles connected with respective front and rear radius arms. Basically, this is just a bottom view of the preceding FIG. 1C.

FIG. 10E is a perspective view from further above FIG. 10C and in front of the medial side (inside) of a frame rail, showing the front (on the lower left hand side) and rear (on the upper right hand side) axles connected with respective front and rear radius arms. Here, more of the rear radius arm 102 bracket 108 may be seen.

FIG. 10F is a plan view of the bottom side of the chassis with radius arms of FIG. 10A, showing the front (on the left hand side) and rear (on the right hand side) axles connected with respective front 610 and rear 102 radius arms.

FIG. 10G is a plan view of the front of the chassis with radius arms of FIG. 10A, showing the front axle connected with one of the front radius arms 610 mounted to one of the two radial sections 614 of the modified mount 612.

FIG. 10H is a perspective view from above and to the rear passenger side of the distal side (outside) of the chassis with radius arms of FIG. 10A, showing the front (on the upper right hand side) and rear axles (on the lower left hand side) connected with respective front 610 and rear 102 radius arms. Here, the front radius arm 610 is mounted to the modified mount 612, while the rear radius arm 102 is mounted to the distal 114 side (outside) of the frame 104. In this view, the bracket 108 is easily understood.

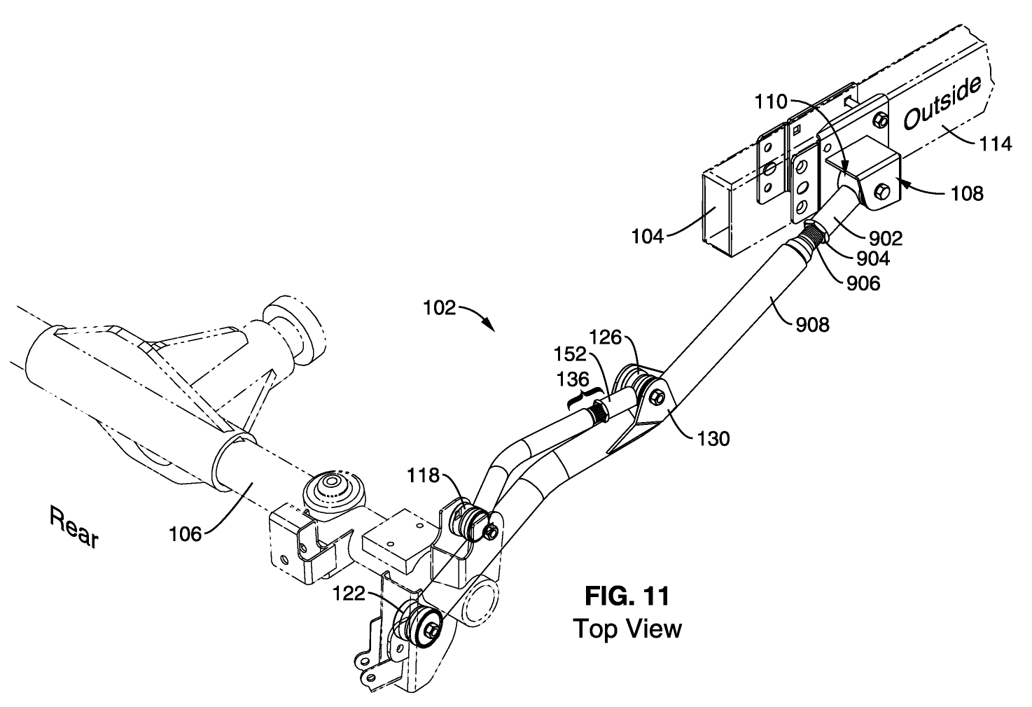

FIG. 11 is an enlarged perspective view from above and to the rear passenger side of the distal side (outside) of the chassis with radius arms of FIG. 10H, showing the detailed mounting of the rear axle via the rear radius arm to the frame.

Here, the rear axle 106 connects to the rear radius arm 102 through the upper compliant pivot 118 and the lower compliant pivot 122. The upper compliant pivot 118 and the intermediate compliant pivot 126 connect with a length adjustment 136. Continuing up the control arm body 908, a threaded section 906 threads into a bolt 904 welded to a neck 902 where a movable joint 110 mounts to the bracket 108. As may be seen from the drawing, bracket 108 mounts to the distal side 114 (outside) of the frame 104.

As stated previously movable joint 110 allows for rotational and some limited degree of spherical compliance, as so the upper compliant pivot 118, the lower complaint pivot 122, and the intermediate compliant pivot 126. The compliances of these various pivots allow for purely rotational movements at the pivots so that the axle 106 may move through a radial arc centered about the movable joint 110.

Additionally, due to the compliant nature of the upper compliant pivot 118, the lower complaint pivot 122, and the intermediate compliant pivot 126, as well as the partially spherical nature of the movable joint 110, now the rear axle 106 may twist, so that one side of the axle is closer to the frame than the other. Such twisting action is known as articulation. In the absence of the compliant pivots, such articulation is not possible, and the rear axle, rear axle radius arm, and the frame would allow only a single degree of freedom rotation about movable joint 110, and no articulation would be possible.

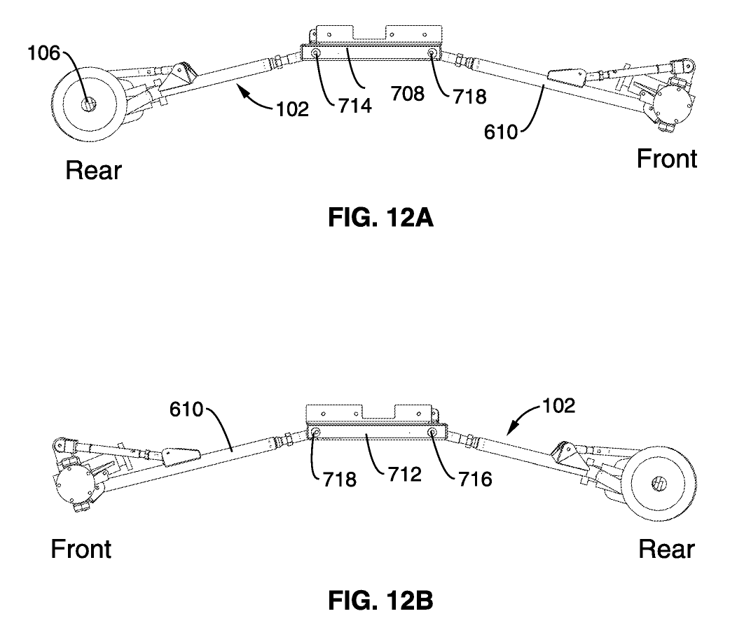

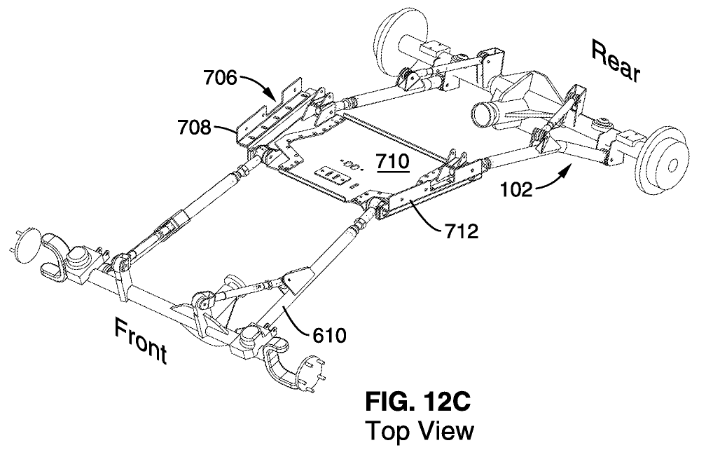

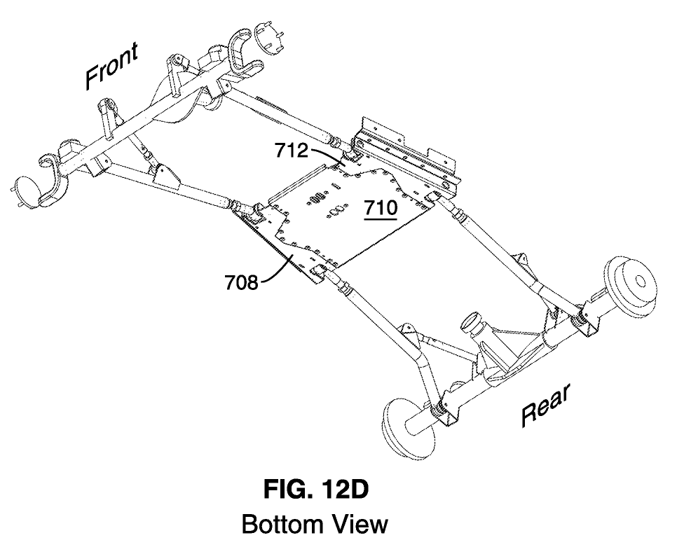

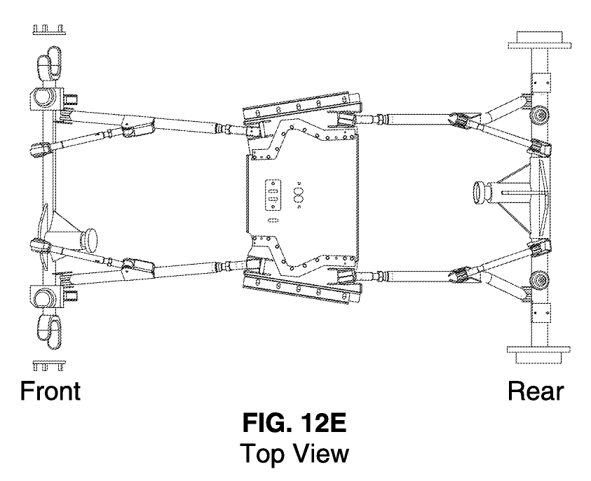

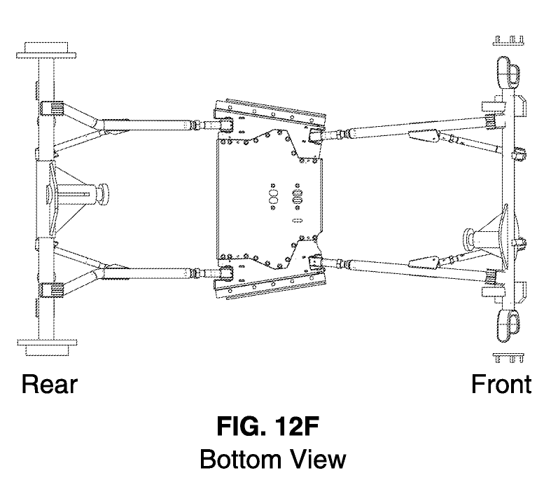

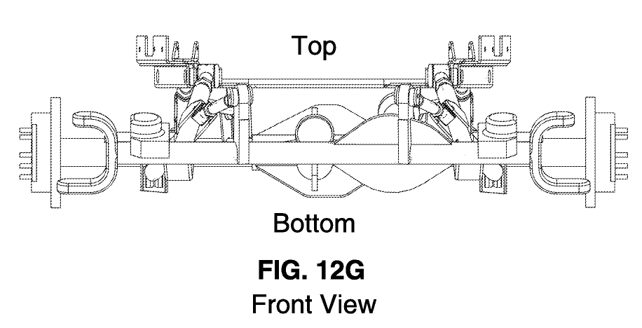

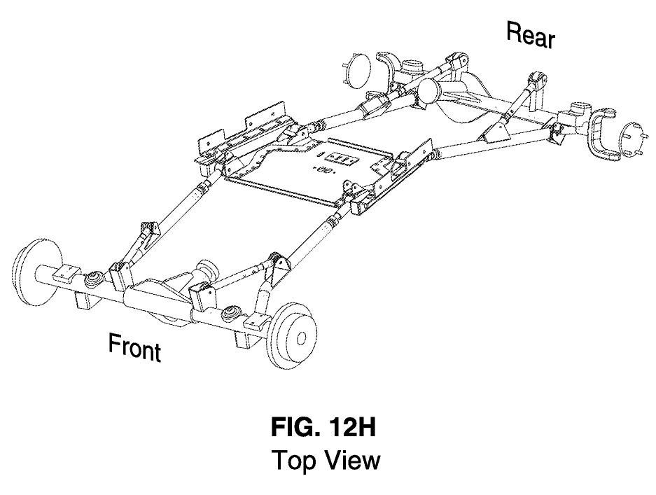

Refer now to FIGS. 12A-12H, which are various detailed views of the retrofit of the first type of off road vehicle shown previously in FIGS. 7A-7C, with aftermarket modifications made in FIGS. 7B and 7C. Various preceding figures are relied upon for the element numberings to minimize confusion.

FIG. 12A is a plan view of the distal side (outside) of a chassis with radius arms, showing the front (on the right hand side) and rear (on the left hand side) axles connected with respective front 610 and rear 102 radius arms. Here, the rear axle 106 attaches through the rear axle radius arm 102 to a pivot mount 714 on the first lateral support 708, which continues forward to connect the front radius arm 610 via front radius arm mount 718.

FIG. 12B is a plan view of the medial side (inside) of the chassis with radius arms of FIG. 12A, showing the front (on the left hand side) and rear (on the right hand side) axles connected with respective front and rear radius arms. This view is basically the same as FIG. 12A, except the rear radius arm 102 attaches through pivot mount 716 to a second lateral support 712. Similarly, the front radius arm 610 attached to the second lateral support 712 through front radius arm mount 718.

FIG. 12C is a perspective view from above and to the front driver side of the distal side (outside) of the chassis with radius arms of FIG. 12A, showing the front (on the lower left hand side) and rear (on the upper right hand side) axles connected with respective front 610 and rear 102 radius arms. Here, the aftermarket transmission and radius arm mount 706 (comprised of the first lateral support 708, the center support 710, and the second lateral support 712) provides a connection point for the front 610 and read 102 radius arms.

FIG. 12D is a perspective view from below and in front of the medial side (inside) of the chassis with radius arms of FIG. 12A, showing the front (on the upper left hand side) and rear (on the lower right hand side) axles connected with respective front and rear radius arms. Here, the first lateral support 708, the center support 710, and the second lateral support 712 are clearly seen.

FIG. 12E is a perspective view from further above FIG. 12C and in front of the medial side (inside) of a frame rail, showing the front (on the lower left hand side) and rear (on the upper right hand side) axles connected with respective front and rear radius arms. This is yet another view of these components.

FIG. 12F is a plan view of the bottom side of chassis with radius arms of FIG. 12A, showing the front (on the left hand side) and rear (on the right hand side) axles connected with respective front and rear radius arms.

FIG. 12G is a plan view of the front of the chassis with radius arms of FIG. 12A, showing the front axle connected with one of the front radius arms mounted to one of the two radial sections.

FIG. 12H is a perspective view from above FIG. 12C and to the front driver side of the distal side (outside) of chassis with radius arms of FIG. 12A, showing the front (on the upper right hand side) and rear axles (on the lower left hand side) connected with respective front and rear radius arms.

### CONCLUSION

When vehicles are raised beyond their factory or stock ride height (otherwise known as ‘lifted’), handling typically deteriorates, and driveline components suffer due to lifted operation outside of their design envelopes. The radius arm geometries disclosed here improves the handling of ‘lifted’ vehicles by reducing the chassis-induced roll-oversteer. The rear axle radius arm design is a departure from the factory geometry in two ways.

First, the rear axle radius arm is significantly longer than the stock configuration, which has the effect of reducing the change in wheelbase that occurs throughout the range of motion. The axle movement causes the change in wheelbase as the axle is constrained by the control arms. As the control arms become longer, the radius of the suspension stroke becomes larger, and the result is a reduced horizontal component within the vertical range of motion (commonly called suspension stroke). Changes in the horizontal component of the suspension stroke cause the vehicles wheelbase (distance between front and rear wheels) to change which results in a secondary turning component. The most common time to feel the effects of this secondary turning component are when intentionally turning the vehicle. The driver will turn the steering wheel an amount necessary to initiate a constant radius turn. The vehicle body will roll in relation to the suspension system as a result of centrifugal force. The compressed side of the vehicles suspension will increase the wheelbase on that side only, while the unloaded suspension will reduce the wheelbase on the opposite side of the vehicle. The result of this wheelbase asymmetry is a turning force that requires the driver to reduce the initial steering input in order to realize the turning radius that was originally input by the steering wheel. This effect is called chassis induced roll oversteer.

Secondly, the rear axle radius arms have a single point of frame attachment, instead of the relatively shorter factory four bar linkage, which reduces unwanted rear axle steer, relative to the suspension stroke. These two attributes work together to improve the handling of the lifted vehicle. The rear radius arm disclosed here accomplishes these handling improvements with a unique design that captures four mounting points (upper and lower on both sides) of the stock axle that were designed for the factory four bar linkage design, and adds another compliant bushing in the rear axle radius arm itself to provide the necessary movement in what would otherwise be a fully constrained rear axle suspension design. The use of this additional bushing is a design unique to this invention and is another reason why these rear axle radius arms improve vehicle handling so well.

Although the description above contains many details, these should not be construed as limiting the scope of the invention but as merely providing illustrations of some of the presently preferred embodiments of this invention. Therefore, it will be appreciated that the scope of the present invention fully encompasses other embodiments which may become obvious to those skilled in the art, and that the scope of the present invention is accordingly to be limited by nothing other than the appended claims, in which reference to an element in the singular is not intended to mean “one and only one” unless explicitly so stated, but rather “one or more.” All structural, chemical, and functional equivalents to the elements of the above-described preferred embodiment that are known to those of ordinary skill in the art are expressly incorporated herein by reference and are intended to be encompassed by the present claims. Moreover, it is not necessary for a device or method to address each and every problem sought to be solved by the present invention, for it to be encompassed by the present claims. Furthermore, no element, component, or method step in the present disclosure is intended to be dedicated to the public regardless of whether the element, component, or method step is explicitly recited in the claims. No claim element herein is to be construed under the provisions of 35 U.S.C. 112, sixth paragraph, unless the element is expressly recited using the phrase “means for.”

What is claimed is:

1. A rear axle radius arm, comprising:
(a) a frame on one side of a vehicle; and
(b) means for linking a rear axle to the frame.

2. The rear axle radius arm of claim 1, wherein the means for linking the rear axle to the frame comprises:
(a) a bracket attached to the frame;
(b) the frame comprising:
(i) a medial side closer to a front-to-back medial plane of substantial symmetry in the vehicle;
(ii) a distal side further away from the medial plane than the medial side; and
(iii) a bottom side; and
(c) a radius arm movably attached to the bracket;
(d) wherein the radius arm movably connects the rear axle to the bracket.

3. The rear axle radius arm of claim 1, wherein the means for linking the rear axle to the frame comprises:
(a) a movable joint that connects to the frame;
(b) a first compliant pivot that attaches to a first mount on the rear axle; and
(c) a second compliant pivot that attaches to a second mount on the rear axle.

4. The rear axle radius arm of claim 3, wherein the means for linking the rear axle to the frame comprises:
(a) an intermediate compliant pivot disposed between the movable joint and the second compliant pivot.

5. The rear axle radius arm of claim 3, wherein the means for linking the rear axle to the frame comprises:
(a) a substantially noncompliant intermediate attachment point disposed between the movable joint and the second compliant pivot, wherein the first compliant pivot, the second compliant pivot, and the movable joint are rigidly connected by a substantially rigid connection (aside from temporary recoverable deformations due to torsion and bending).

6. The rear axle radius arm of claim 2, wherein the bracket comprises:
(a) a doubler plate attached to a first side of a frame;
(b) a cuff attached to a lower side of the frame and through a second side of the frame opposing the first side of the frame to the doubler plate;
(c) a control arm mount attached to the cuff, comprising a shaft wherein a movable link may be rotationally or spherically movably attached to the shaft.

7. The rear axle radius arm of claim 2, wherein the radius arm comprises:
(a) a lower control arm that comprises:
(i) a lower compliant pivot that connects to a lower mount on the rear axle at one end; and
(ii) a movable joint that connects to the bracket mount located on the frame at the other end; and
(iii) an upper control arm bracket located between the lower compliant pivot and the movable joint; and
(b) an upper control arm that comprises:
(i) an upper compliant pivot that connects to an upper mount on the rear axle at one end; and
(ii) an intermediate compliant pivot that connects to the upper control arm bracket.

8. The rear axle radius arm of claim 2, comprising:
(a) one rear axle radius arm on each side of the medial plane of the automobile; and
(b) a center of rear suspension rotation, comprising:
(i) a line drawn between the two brackets attached to the frame that substantially intersects a center of rotation of a double Cardan joint;
(ii) wherein the double Cardan joint is connected at one end to a drive shaft that connects a differential, and at the other end to an output of a rotational power source.

9. The rear axle radius arm of claim 8, wherein the rotational power source comprises either a transfer case or a transmission.

10. The rear axle radius arm of claim 8, wherein each of the radius arms on each side of the medial plane are substantially mirror images of each other.

11. The rear axle radius arm of claim 7:
(a) wherein the lower mount on the rear axle was previously attached to a factory installed rear lower control link; and
(b) wherein the upper mount on the rear axle was previously attached to a factory installed rear upper control link.

12. The rear axle radius arm of claim 2, wherein the bracket comprises an aftermarket bracket attached to the frame.

13. The rear axle radius arm of claim 2, wherein the bracket is attached to the distal side of the frame.

14. The rear axle radius arm of claim 13, wherein the bracket comprises:
(a) a stamped locator that precisely locates the bracket by a factory frame precision reference locator.

15. The rear axle radius arm of claim 2, wherein the bracket is attached to the medial side of the frame.

16. The rear axle radius arm of claim 15, wherein the bracket comprises:
(a) a stamped locator that precisely locates the bracket by a factory frame precision reference locator.

17. The rear axle radius arm of claim 2, wherein the bracket is attached to the bottom side of the frame.

18. The rear axle radius arm of claim 7, wherein one or more of the upper compliant pivot, the intermediate compliant pivot, and the lower compliant pivots allow for both rotational and tilt movements out of a plane of nominal rotation.

19. The rear axle radius arm of claim 2, wherein the bracket attaches to the frame with components that comprise:
(a) a cuff comprising a lower lip;
(b) the bracket attached to the cuff;
(c) a doubler plate;
(d) wherein the radius arm attaches to the bracket; and
(e) wherein the cuff bolts through the frame to the doubler plate; and
(f) wherein the cuff lower lip attaches through the bottom side of the frame to a plate with retained fasteners.

20. The rear axle radius arm of claim 18, wherein each of the upper compliant pivot, the intermediate compliant pivot, and the lower compliant pivots comprise:
(a) a housing;
(b) a thick-walled tubular compliant bushing disposed within the housing; and
(c) two caps that protrude into the inner diameter of the tubular compliant bushing that allow passage of a central shaft;
(d) wherein the housing and caps limit translational movement of the central shaft within the housing through limited deformation of the compliant bushing.

21. A method for retrofitting a rear axle connection to a frame with a set of two radius arms, the method for retrofitting each of the radius arms comprising:
(a) providing a rear axle comprising an upper control link mount and a lower control link mount, wherein both upper and lower control link mounts respectively connect to rear lower and rear upper control links that are in turn connected to the factory frame, such that the upper control link, the lower control link, the axle, and the frame form a moveable four-bar linkage wherein the axle moves relative to the frame;
(b) removing the upper control link and the lower control link;
(c) attaching a bracket mount to the frame; and
(d) installing a rear axle radius arm to the bracket mount, wherein the rear axle radius arm comprises:
(i) a lower radius control arm that spherically mounts to the frame bracket mount and the lower axle bracket mount; and
(ii) an upper radius arm that pivotally mounts to the upper radius arm bracket on the lower radius arm on one end, and pivotally attaches to the axle upper control link mount at the other end.

22. A rear axle radius arm, comprising:
(a) a frame on one side of an automobile, wherein the automobile has a vertical medial plane, and the frame has medial side closer to the medial plane, and a distal side further away from the vertical medial plane than the medial side; and
(b) means for linking a rear axle to the frame.

23. The rear axle radius arm of claim 22, wherein the means for linking the rear axle to the distal side of the frame comprises:
(a) a bracket mount located on the distal side of the frame; and
(b) a radius arm movably attached to the bracket mount;
(c) wherein the radius arm movably connects the rear axle to the bracket mount.

24. A serviceable rear axle radius arm mount, comprising:
(a) a vehicle chassis in a vehicle; and
(b) means for mounting two rear axle radius arms to the chassis.

25. The serviceable rear axle radius arm mount of claim 24, wherein the means for mounting comprises:
(a) a rear axle radius arm mount attached to the chassis; and
(b) a separately removable section that may be separately removed from the rear axle radius arm mount;
(c) wherein the rear axle radius arm has a substantially constant alignment both prior to and after removal of the separately removable section.

26. The serviceable rear axle radius arm mount of claim 25, comprising:
(a) two frames substantially bilaterally disposed about a vertical medial plane of substantial vehicle symmetry;
(b) two frame mounts bilaterally disposed about a separately removable section;
(i) wherein each frame mount attaches to the vehicle chassis through one of the frames on one side, and to the separately removable section on the other side;
(ii) wherein each frame mount has a pivot connection to a rear axle radius arm; and
(c) each rear axle radius arm substantially radially connects the rear axle to the vehicle chassis.

27. A serviceable transmission mount with front radius arm mounts, comprising:
(a) a vehicle frame; and
(b) means for mounting two front radius arms, the means for mounting attached to the vehicle frame; and
(c) means for supporting a transmission attached to the means for mounting the two front radius arms.

28. The serviceable transmission mount with front radius arm mounts of claim 27 wherein the means for supporting the transmission is separately removable from the means for mounting the two front radius arms.

29. The serviceable transmission mount with front radius arm mounts of claim 27, wherein:
(a) the means for supporting the transmission comprises:
(i) a structural member bolted to the transmission and removably bolted to the means for mounting the two front radius arms.

30. The serviceable transmission mount with front radius arm mounts of claim 27, wherein a vehicle front end (that comprises front radius arms) remains in substantially identical front wheel alignment before removal and after replacement of the means for supporting the transmission.

31. The serviceable transmission mount with front radius arm mounts of claim 27 wherein the means for mounting the two front radius arms comprises means for mounting two rear radius arms.
